(19) United States
(12) Patent Application Publication
(10) Pub. No.: US 2025/0237054 A1
(43) Pub. Date: Jul. 24, 2025

(54) INSULATED PANELS WITH SENSORS AND LIGHT DEVICES, INSULATED PANEL NETWORK SYSTEMS, AND METHODS OF MANUFACTURING THE INSULATED PANELS AND UTILIZING THE INSULATED PANEL NETWORK SYSTEMS

(71) Applicant: Nucor Insulated Panel Group, LLC, Wilmington, DE (US)

(72) Inventors: David Brett Clay, Sanger, TX (US); Errol Paul Schendeler, Denton, TX (US)

(73) Assignee: Nucor Insulated Panel Group, LLC, Wilmington, DE (US)

(21) Appl. No.: 19/024,419

(22) Filed: Jan. 16, 2025

Related U.S. Application Data
(60) Provisional application No. 63/624,674, filed on Jan. 24, 2024.

(51) Int. Cl. E04B 1/80; G01B 21/32; G01D 3/08; G08B 21/18; H05B 47/175

(52) U.S. Cl. CPC E04B 1/80; G01B 21/32; G01D 3/08; G08B 21/182; H05B 47/175

(57) ABSTRACT

Insulated panels with sensors (e.g., pressure, temperature, humidity, gas, wind, or the like) allow for feedback regarding the structure and/or the conditions around the structure in order to allow for identifying potential issues and taking actions with respect to such potential issues. The insulated panels with light devices allow for incorporation of lighting within the insulated panels to provide exterior and/or interior lighting of the structure. The sensors and/or light devices of the insulated panels may communicate with each other through the use of panel hubs that allow signals (e.g., wired, wireless, or the like) to be transferred between insulated panels and/or with a primary hub using an insulated panel network system for monitoring and operating components of the structure. Improved manufacturing processes are provided that allow for manufacturing the insulated panels with sensors, light devices, and/or the panel hubs, and electrical connections therebetween.

### PRIORITY CLAIM UNDER 35 U.S.C. § 119

The present Application for a Patent claims priority to U.S. Provisional Patent Application Ser. No. 63/624,674 titled “Insulated Panels with Sensors and Light Devices, Insulated Panel Network Systems, and Method of Manufacturing the Insulated Panels and Utilizing the Insulated Panel Network Systems”, filed on Jan. 24, 2024, both of which are assigned to the assignee hereof and hereby expressly incorporated by reference herein.

### FIELD

This application relates generally to the field of insulated panels for buildings, and more particularly, to insulated sensor and/or lighting panels.

### BACKGROUND

Current building envelope methodology provides insulation for thermal protection. Present systems do not provide other components integrated into the panel, including any feedback regarding the operation of the panels. There is a need for providing improved insulated panels.

### BRIEF SUMMARY

Embodiments of the present disclosure relate to improved insulated panels that incorporate sensor(s), panel hub(s), and/or light device(s). The insulated panels with sensors (e.g., pressure, temperature, humidity, gas, wind, position, location, vision, or the like) allow for feedback regarding the structure, elements within or outside of the structure (e.g., equipment, material coupled to the equipment, people, or the like), and/or the conditions around that structure in order to allow for identifying potential issues and taking actions with respect to such potential issues. The insulated panels with light devices allow for incorporation of lighting within the insulated panels to provide exterior and/or interior lighting of the structure. The sensors and/or light devices of the insulated panels may communicate with each other through the use of panel hubs that allow signals (e.g., wired, wireless, or the like) to be transferred between insulated panels and/or with a primary hub (otherwise described a master hub) using an insulated panel network system. Furthermore, the hubs may allow for wired or wireless energy transfer between the sensors, lighting, and/or hubs to provide power between the sensors. Moreover, the present disclosure includes improved manufacturing processes that allow for manufacturing the insulated panels with sensors, panel hubs, light devices, and/or connections therebetween for energy transfer. Finally, the data (otherwise described as “information” or “feedback”) obtained from the sensors and/or hubs may be analyzed (e.g., through the use of artificial intelligence (AI), machine learning (ML), or the like) in order to optimize the operation of the structure (e.g., building), systems of the structure, and/or elements within or outside of the structure to improve operation of systems, improve safety, reduce energy consumption, or the like.

One embodiment of the present disclosure is an insulated panel comprising a first substrate, a second substrate, an insulation material located between the first substrate and the second substrate. Moreover, the insulated panel further comprises one or more sensors located at least partially within the insulation material, or one or more light devices operatively coupled to the first substrate or the second substrate.

In further accord with embodiments, the insulated panel comprises the one or more sensors and the one or more light devices.

In other embodiments, the insulated panel further comprises a panel hub. The panel hub is configured to communicate with a main hub that is configured to communicate with a plurality of panel hubs of a plurality of insulated panels.

In still other embodiments, the insulated panel further comprises a panel hub housing located at least partially within the insulation material that at least partially encloses the panel hub.

In yet other embodiments, the panel hub housing is made at least partially from the insulation material.

In other embodiments, the panel hub is operatively coupled to the one or more sensors through a wired connection or a wireless connection.

In further accord with embodiments, the first substrate or the second substrate comprises a circuit, and the panel hub and the one or more sensors are operatively coupled through the circuit.

In other embodiments, the circuit is a printed circuit on the first substrate or the second substrate.

In still other embodiments, the insulated panel further comprises one or more electrical connectors. The one or more electrical connectors operatively couple the one or more sensors of the insulated panel with one or more adjacent sensors of one or more adjacent insulated panels through wired connectors.

In yet other embodiments, the insulated panel further comprises one or more electrical connectors. The one or more electrical connectors are embedded into an edge or end of the insulated panel and operatively couple the insulated panel with one or more adjacent insulated panels when assembled on a structure.

In other embodiments, the one or more sensors comprise one or more pressure sensors. The one or more pressure sensors are configured to indicate structural changes in the insulated panel or a structure on which the insulated panel is installed.

In further accord with embodiments, the one or more sensors comprise one or more position sensors. The one or more position sensors are configured to indicate structural changes in the insulated panel, a structure, or elements within the structure.

In other embodiments, the one or more sensors comprise one or more location sensors. The one or more location sensors are configured to indicate a location of the insulated panel on a structure.

In still other embodiments, the one or more sensors comprise one or more vison sensors. The one or more vision sensors are configured to monitor elements outside or within a structure.

In yet other embodiments, the one or more sensors comprise one or more smoke sensors. The one or more smoke sensors are configured to indicate the presence of a fire.

In other embodiments, the one or more sensors comprise one or more temperature sensors. The one or more temperature sensors are configured to indicate the presence of a fire, an issue with the insulated panel, or utilized for climate control of a structure.

In further accord with embodiments, the one or more sensors comprise one or more humidity sensors. The one or more humidity sensors are configured to indicate an issue with a structure or utilized for climate control of the structure.

In other embodiments, the one or more sensors comprise one or more air flow sensors. The one or more air flow sensors are configured to aid in regulating air flow within a structure or utilized for climate control of the structure.

In still other embodiments, the one or more light devices are operatively coupled to an edge of the insulated panel. The one or more light devices are exposed on an outer face of the insulated panel for lighting an exterior of a structure or the one or more light devices are exposed on an inner face of the insulated panel for lighting an interior of a structure.

Another embodiment of the present disclosure is an insulated panel system comprising a plurality of insulated panels. Two or more of the plurality of insulated panels comprise a first substrate, a second substrate, an insulation material located between the first substrate and the second substrate, one or more sensors located at least partially within the insulation material, or one or more light devices operatively coupled to the first substrate or the second substrate. Two or more of the plurality of insulated panels may further comprise a panel hub operatively coupled to the first substrate, the second substrate, or insulation material. The insulated panel system further comprises a controller operatively coupled to the panel hub, the one or more sensors or the one or more light devices of the two or more of the plurality of insulated panels. The controller comprises one or more memory devices with computer-readable program code stored thereon, and one or more processing devices operatively coupled to the one or more memory devices. When executed the computer-readable program code is configured to direct the one or more processing devices to receive sensor output from the one or more sensors and send a sensor notification regarding the sensor output, or provide light commands to the one or more light devices to control the one or more light devices.

Another embodiment of the present disclosure is a method of operating an insulated panel system. The insulated panel system comprises a plurality of insulated panels. Two or more of the plurality of insulated panels comprise one or more sensors located at least partially within insulation material between a first substrate and a second substrate, or one or more light devices operatively coupled to the first substrate or the second substrate. Two or more of the plurality of insulated panels further comprise a panel hub operatively coupled to the first substrate, the second substrate, or the insulation material. The method comprises receiving, via one or more processing devices, sensor data from the one or more sensors and sending a sensor notification regarding the sensor data. Alternatively, or additionally, the method comprises providing, via the one or more processing devices, light commands to the one or more light devices to control the one or more light devices.

Another embodiment of the present disclosure is a method of manufacturing an insulated panel. The method comprises providing a first substrate adjacent a second substrate. The method further comprises applying insulation material between the first substrate and the second substrate through continuous manufacturing systems or discontinuous manufacturing systems. The method also comprises installing one or more sensors or a panel hub by operatively coupling the one or more sensors or the panel hub to the first substate, the second substrate, or the insulation material, before or after the insulation material is applied between the first substrate and the second substrate. The method further comprises optionally installing one or more light devices by operatively coupling the one or light devices to the insulated panel.

To the accomplishment of the foregoing and the related ends, the one or more embodiments of the disclosure comprise the features hereinafter fully described and particularly pointed out in the claims. The following description and the annexed drawings set forth certain illustrative features of the one or more embodiments. These features are indicative, however, of but a few of the various ways in which the principles of various embodiments may be employed, and this description is intended to include all such embodiments and their equivalents.

### BRIEF DESCRIPTION OF DRAWINGS

The accompanying drawings illustrate some of the embodiments of the disclosure and are not necessarily drawn to scale, wherein:

FIG. 1 illustrates a perspective view of a barrier system having a plurality of barrier panels installed on support members, in accordance with embodiments of the present disclosure;

FIG. 2A illustrates a front perspective view of a heavy gauge barrier panel being installed on an I-beam support member, in accordance with embodiments of the present disclosure;

FIG. 2B illustrates a rear perspective view of the heavy gauge barrier panel of FIG. 2A that also utilizes a rear connection, in accordance with embodiments of the present disclosure;

FIG. 3A illustrates a front perspective view of a light gauge barrier panel being installed on an z-shaped support member, in accordance with embodiments of the present disclosure;

FIG. 3B illustrates a rear perspective view of the light gauge barrier panel of FIG. 3A that also utilizes a rear connection, such as a rivets, in accordance with embodiments of the present disclosure;

FIG. 4A illustrates an end view of an insulated panel, in accordance with embodiments of the present disclosure;

FIG. 4B illustrates a cross-sectional view of a first insulated panel being assembled with a second insulated panel along the edges, in accordance with embodiments of the present disclosure;

FIG. 4C illustrates a cross-sectional view of first and second insulated panels assembled along the edges, in accordance with embodiments of the present disclosure;

FIG. 5 illustrates a perspective and enlarged view of a flat insulated panel, in accordance with embodiments of the present disclosure;

FIG. 6 illustrates a schematic diagram of an insulated sensor panel with various sensors, in accordance with embodiments of the present disclosure;

FIG. 7 illustrates a schematic diagram of an insulated sensor panel with wired connections, in accordance with embodiments of the present disclosure;

FIG. 8A illustrates a schematic diagram of an insulated sensor panel with printed circuit connections, in accordance with embodiments of the present disclosure;

FIG. 8B illustrates a schematic diagram of using sensors with one or more pins that may be operatively coupled to the circuit on the substrate before or during application of the insulation material;

FIG. 9 illustrates a panel sensor system, in accordance with embodiments of the present disclosure;

FIG. 10A illustrates a panel hub apparatus being assembled, in accordance with embodiments of the present disclosure;

FIG. 10B illustrates a panel hub apparatus assembled, in accordance with embodiments of the present disclosure;

FIG. 11 illustrates an insulated lighting panel, in accordance with embodiments of the present disclosure;

FIG. 12 illustrates a light for an insulated lighting panel, in accordance with embodiments of the present disclosure;

FIG. 13A illustrates a schematic diagram of a continuous panel manufacturing line with a laminator, in accordance with embodiments of the present disclosure;

FIG. 13B illustrates a perspective view of a portion of a continuous panel manufacturing line, in accordance with embodiments of the present disclosure;

FIG. 13C illustrates a perspective view of a portion of a continuous panel manufacturing line, in accordance with embodiments of the present disclosure;

FIG. 14A illustrates a perspective view of a static applicator dispensing a liquid insulation material, in accordance with embodiments of the present disclosure;

FIG. 14B illustrates a perspective view of a static applicator dispensing a foam insulation material, in accordance with embodiments of the present disclosure;

FIG. 14C illustrates the insulation material expanding in the liner entry before the laminator, in accordance with embodiments of the present disclosure;

FIG. 14D illustrates a perspective side view of the laminator, in accordance with embodiments of the present disclosure;

FIG. 14E illustrates a perspective end view of the laminator, in accordance with embodiments of the present disclosure;

FIG. 15A illustrates a perspective view of a discontinuous panel manufacturing line with static molds, in accordance with embodiments of the present disclosure;

FIG. 15B illustrates a perspective view of a discontinuous panel manufacturing line with a dynamic applicator and static molds, in accordance with embodiments of the present disclosure;

FIG. 16 illustrates a perspective view of an insulated sensor panel being manufactured, in accordance with embodiments of the present disclosure;

FIG. 17 illustrates an enlarged perspective view an insulated sensor panel being manufactured, in accordance with embodiments of the present disclosure;

FIG. 18 illustrates an enlarged perspective view of an insulated sensor panel being manufactured, in accordance with embodiments of the present disclosure;

FIG. 19 illustrates an enlarged perspective view of an insulated sensor panel with a panel hub being manufactured, in accordance with embodiments of the present disclosure;

FIG. 20 illustrates an insulated panel system, in accordance with embodiments of the present disclosure;

FIG. 21 illustrates a process for manufacturing insulated panels with sensors and/or light devices, in accordance with embodiments of the present disclosure; and

FIG. 22 illustrates a process for installing the insulated panels and/or operating the insulated panel system, in accordance with embodiments of the present disclosure.

### DETAILED DESCRIPTION

Embodiments of the present disclosure now may be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure may satisfy applicable legal requirements. Like numbers refer to like elements throughout.

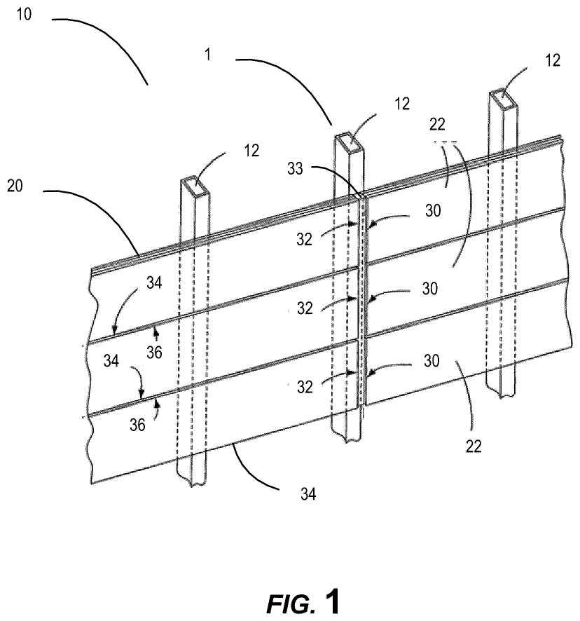

FIG. 1 illustrates a portion of building envelope system 10, in accordance with the teachings of the present disclosure. The building envelope system 10 includes support members 12 (e.g., vertical support members, such as studs, I-beams, H-beams, c-channels, w-channels, rectangular-channels, z-channels, or the like made of any material), which are structurally connected to other building support members (e.g., floors, girders, joists, columns, or the like) directly or indirectly. A barrier panel system having barrier panels may be attached to the support members 12 to provide one or more benefits, such as air, water, vapor, and/or thermal protection. In some embodiments of the present disclosure, the barrier system is an insulated panel system that uses insulated panels to provide thermal protection. In particular embodiments of the present disclosure, the insulated panel system is an insulated panel sensor system, an insulated panel lighting system, or combined insulated panel sensor and lighting system, or other like insulated panel system. As such, the insulated panel system may be generally referred to herein as an insulated panel system 20 that utilizes insulated panels 22 (e.g., with sensors, such as insulated sensor panels, with light devices, such as insulated light panels, combinations thereof, such as insulated sensor and light panels, or the like), as will be described in further detail herein. In some embodiments, an exterior system (not illustrated) may be attached to the outer surface of the barrier system via an exterior panel connector.

As will be described in further detail herein, the insulated panel system 20 may be utilized in any type of structure (e.g., closed or open building), such as warehouses (e.g., standard, cold-storage, freezer storage, or the like), facilities (e.g., manufacturing facilities, office complexes, commercial facilities, or the like), residential buildings (e.g., apartments, condominiums, or the like), or any other structure. As will be described in further detail herein, the insulated panels with sensors (e.g., pressure, temperature, humidity, gas, wind, position, location, vision, or the like) allows for feedback regarding the structure, elements within the structure, and/or the conditions around that structure in order to allow for identifying potential issues and taking actions with respect to such potential issues. The insulated panels with light devices allow for incorporation of lighting within the insulated panels to provide exterior and/or interior lighting of the structure.

As illustrated in FIGS. 1 through 5, the insulated panels 22, regardless of if they have sensors and/or light devices, may have substrates (otherwise described as faces, skins, or the like), such as a first substrate 24 (e.g., first face, first skin, or the like), and a second substrate 26 (e.g., second face, second skin, or the like). It should be understood that the first substrate 24 may be the exterior face and the second substrate 26 may be interior face; however, the second substrate 26 may be exterior face and the first substrate 24 may be the interior face. The first substrate 24 and/or the second substrate 26 are typically made from steel, such as G90 galvanized steel, for structural strength purposes and to resist corrosion. However, other suitable materials such as ferrous and non-ferrous metallic materials, and combinations of materials, such as aluminum and other similar materials, are also contemplated for the substrates 24, 26. Moreover, the insulated panels 22 may have ends, such as a first end 30 (e.g., left end, proximal end, or the like) and a second end 32 (e.g., right end, distal end, or the like), and edges, such as a first edge 34 (e.g., a lower edge, proximal edge, or the like) and a second edge 36 (e.g., upper edge, distal edge, or the like). As illustrated in FIG. 1, multiple insulated panels 22 may be installed (e.g., such as adjacent the floor, base, or the like) of a structure (e.g., building, or the like) onto one or more support members 12 to form an insulated panel system 20. The insulated panel 22 may extend over two or more support members 12. As illustrated in FIG. 1, a first end 30 of a first panel 22 may butt up to a second end 32 of a second panel 22 (e.g., horizontally end to end). As illustrated in FIG. 1, the ends 30, 32 of adjacent panels 22 may butt up to each other at the locations of a support member 12. However, it should be understood that the ends 30, 32 of adjacent panels 22 may butt up to each other at locations between support members 12. While the ends 30, 32 of the panels 22 are illustrated as butting up to each other, in some embodiments, the ends 30, 32 of the panels 22 may at least partially overlap. Moreover, in some embodiments, end connectors (e.g., fasteners, clips, or the like) may be used to operatively couple the ends 30, 32 of adjacent panels together. Alternatively, or additionally, a seal 33 (e.g., gasket seal, adhesive, caulk, resin, or the like) may be located between a portion of adjacent panels 22, such as the ends 30, 32 of the panels 22 as illustrated in FIG. 1.

As further illustrated in FIGS. 1 through 5, multiple panels 22 may be assembled on top of each other using the edges 34, 36 of the panels 22. For example, as illustrated in FIG. 1, a first edge 34 of one panel 22 may be operatively coupled to a second edge 36 of an adjacent panel 22 (e.g., vertically edge to edge). As illustrated in FIGS. 1 through 5, the edges 34, 36 of the panels 22 may have one or more projections 40 that form one or more cavities 42 on one or both edges 34, 36 of the panels 22. The one or more projections 40 and one or more cavities 42 may be used to interlock a first edge 34 of a first panel 22 with a second edge 36 of an adjacent second panel 22. The interlocking of the edges 34, 36 improves (e.g., reduces or eliminates) the passage of air, water, vapors, heat, or the like between the edges 34, 36 of the adjacent panels 22.

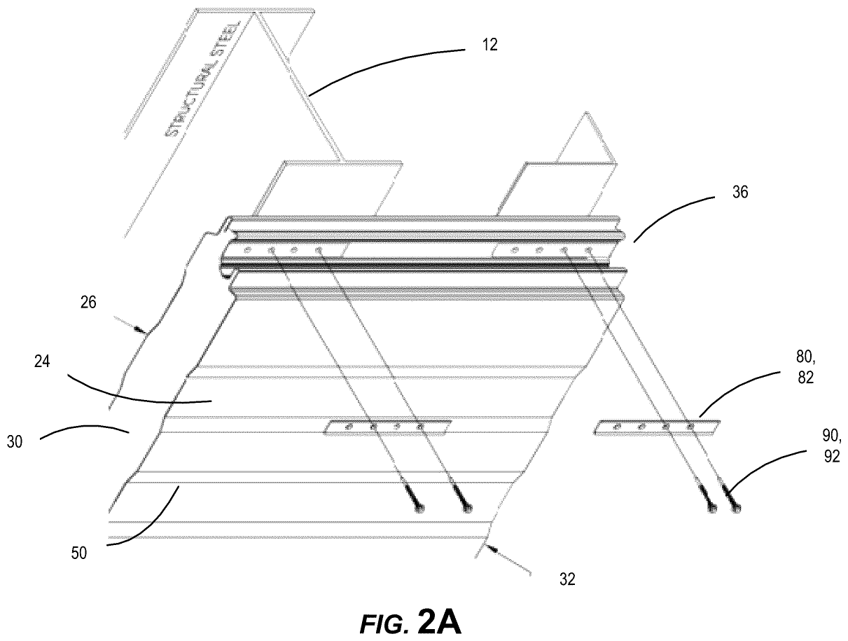

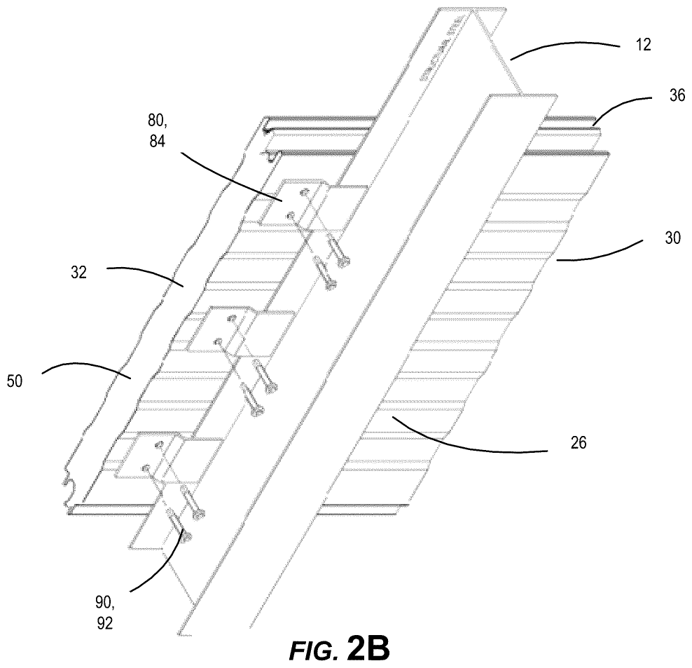

The panels 22 may be operatively coupled to the support members 12 in various ways dependent on the type of panel, weight of the panel, edges 34, 36, ends 30, 32, or the like of the panels 22. For example, referring to FIGS. 2A and 2B, the insulated panel 22 may be a heavy gauge panel (e.g., 20, 22, 24, or the like gauge) that is operatively coupled to a support member 12 such as an I-beam, H-beam, or the like. As illustrated in FIGS. 2A and 2B, the insulated panel 22 may be attached through the use of retainer members 80 (e.g., rectangular, square, oval, uniform, non-uniform, z-shaped, s-shaped, or the like members) that may have one or more apertures therein, and/or connectors 90 (e.g., fasteners 92, such as rivets, screws, bolts, nuts, or the like, clamps, clips, or the like connectors). For example, the edge retainer members 82, such as brackets, may be located within a channel on an edge 34, 36 of the panels 20 and operatively coupled to the support member 12 using the fasteners 92, such as rivets. For example, in some embodiments the edge retainer members 82 may be used to operatively couple the second edge 36 of the panel to the support member 12 using the fasteners 92. Additionally, face retainer members 84 may be used to operatively couple the support member 12 to a second face 26 of the panel 22, as illustrated in FIG. 2B.

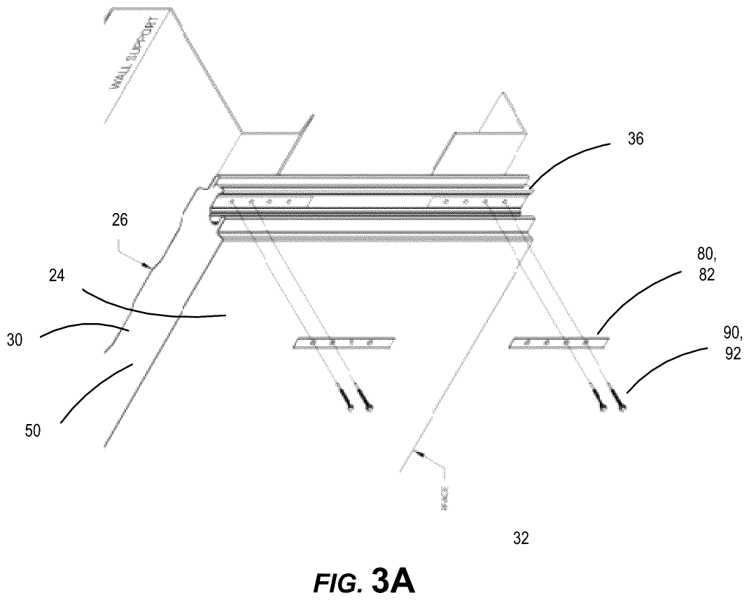

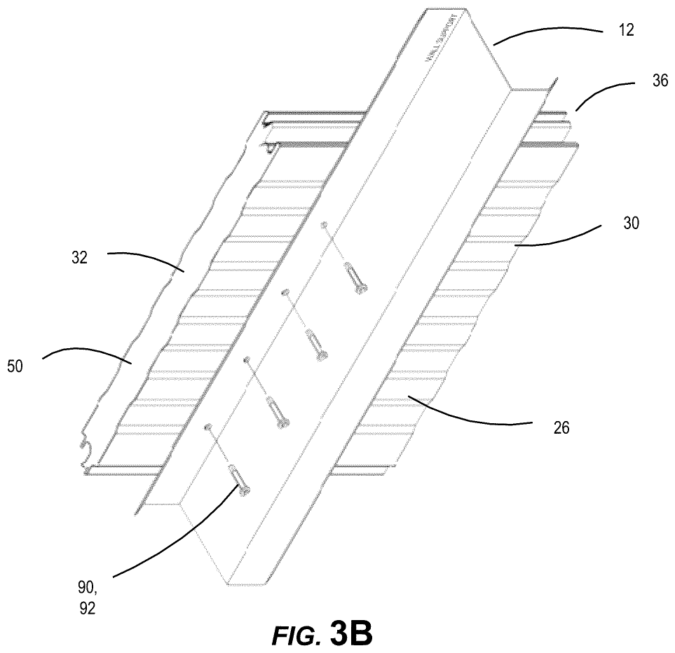

In other examples, referring to FIGS. 3A and 3B, the insulated panel 22 may be a light gauge panel (e.g., 24, 26, 28, or the like gauge) that is operatively coupled a support member 12 that is a z-shaped wall support. As illustrated in FIGS. 3A and 3B, like the insulated panels 22 illustrated in FIGS. 2A and 2B, the insulated panels 22 may be attached through the use of retainer members 80 (e.g., rectangular, square, oval, uniform, non-uniform, z-shaped, s-shaped, or the like members) that may have one or more apertures therein, and/or connectors 90 (e.g., fasteners 92, such as rivets, screws, bolts, nuts, or the like, clamps, clips, or the like connectors). The retainer members 80, such as brackets, may be located within a channel on edges 34, 36 of the panels 20 and operatively coupled to the support member 12 using the fasteners 92. For example, edge retainer members 82 may be located within a channel on an edges 34, 36 of the panels 20 and operatively coupled to the support member 12 using the fasteners 92. However, unlike the connection in FIGS. 2A and 2B, the face retainer members 84 may not be necessary, and instead the connectors 90, such as the fasteners 92, may be used to operatively couple the support member 12 directly to the second face 26 of the panel 22, as illustrated in FIG. 3B.

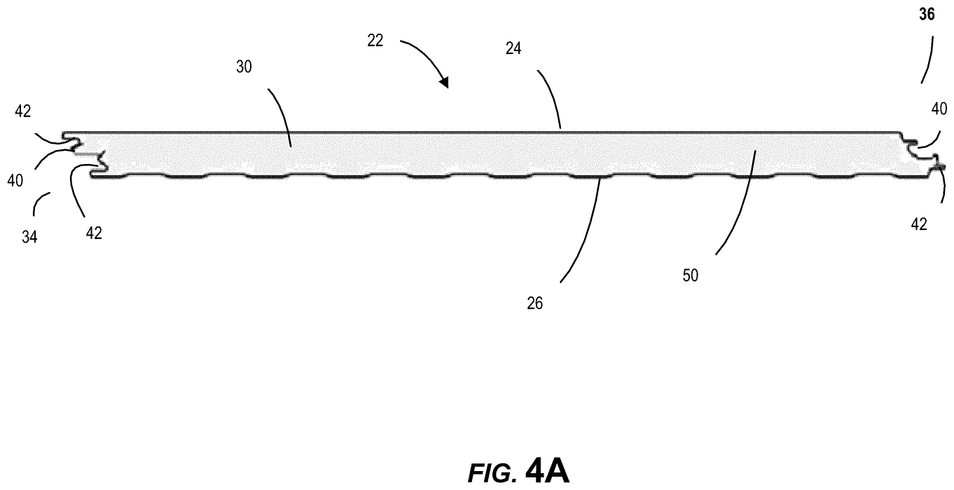

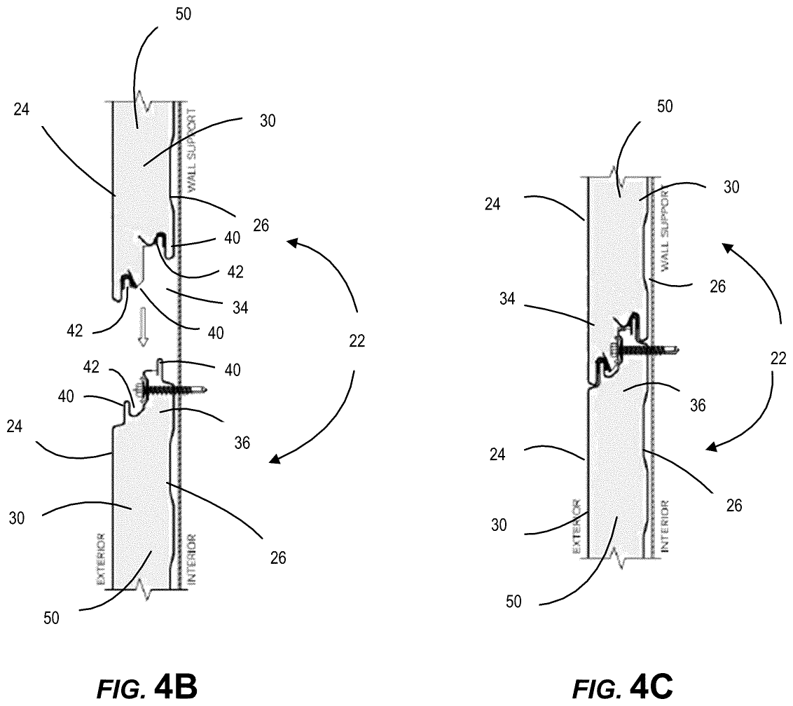

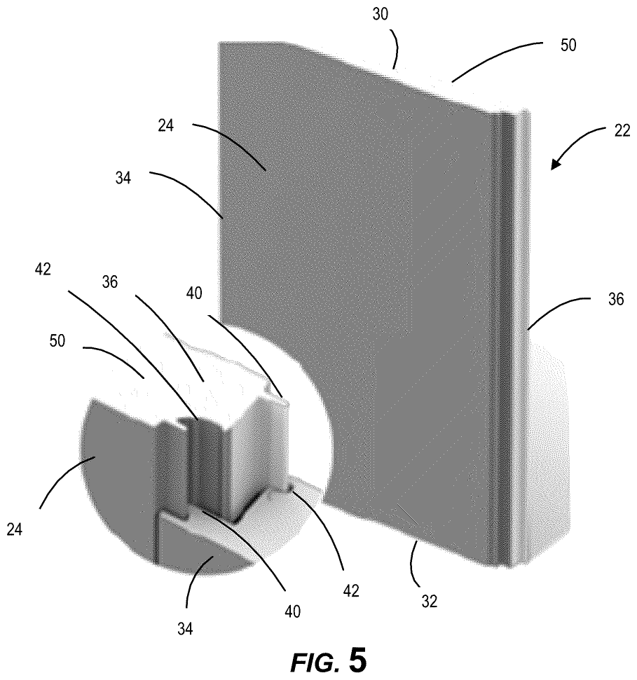

FIGS. 4A through 5 illustrate that one or more projections 40 and one or more cavities 42 formed from the projections 40 may be formed on the first edge 34 of a first panel 22 and a second edge of an adjacent second panel 22 to connect adjacent panels 22. Moreover, while the one or more projections 40 that form the one or more cavities may be illustrated on the first edge 34 and second edge 34, additionally or alternatively, the ends 30, 32 may have one or more projections 40 that form one or more cavities 42. FIG. 5 illustrates one type of panel 22 that may have a first substrate 24 that is flat. Alternatively, other types of panels 22 that include striations in the first substrate 24 (e.g., 1/64, 1/32, 1/16, or the like inches deep, or range between, overlap, or fall outside of these values) may be used. Alternatively, another type of panel 22 that includes corrugations in the first substrate 24 (e.g., 1/16, ⅛, ¼, or the like inches deep, or range between, overlap, or fall outside of these values) may be used. It should be further understood that regardless of whether or not the panels have striations and/or corrugations, the panels 22 may be embossed (e.g., having a pattern or formed texture) or non-embossed. Furthermore, while the panels 22 are illustrated as being flat on the first substrate 24 and second substrate 26, it should be understood that the first substrate and/or the second substrate 26 may or may not have these features. Furthermore, it should be understood that the substrates may have different surface shapes, patterns, and/or sizes.

It should be understood that while particular panels 22 are illustrated herein, any type of panel having any type of shape, configuration, and/or ends or edges may be used as the insulated panel 22 described herein. The insulated panels 22 may include an insulation material 50 (otherwise described as a foam core, or the like) filling the interior space of the insulated panel 22 and adhesively connecting the facing substrates 24, 26 to provide an insulated panel 22.

As will be described in further detail herein, the insulation material 50 is applied as an unexpanded material 52 (e.g., a liquid material, a foamed material 54, depending on the equipment being used) and expands and hardens into the insulation material 50 of the insulated panel 22. Regardless of the type of insulation material 50 and/or how the insulation material 50 is applied, the sensors 400, panel hubs 450, and/or light devices 470, as will be described herein, may be at least partially operatively coupled to the first substrate 24 and/or second substrate 26 before the insulation material is added and cures (e.g., solidifies, or the like). In other embodiments, the sensors 400, panel hubs 450, and/or light devices 470 may be at least partially operatively coupled to the first substrate 24, second substrate 26, and/or the insulation material 50 as the insulation material 50 is applied. In other embodiments, the sensors 400, panel hubs 450, and/or light devices 470 may be at least partially operatively coupled to the first substrate 24, second substrate 26, and/or the insulation material 50 after the insulation material 50 is applied and/or cures.

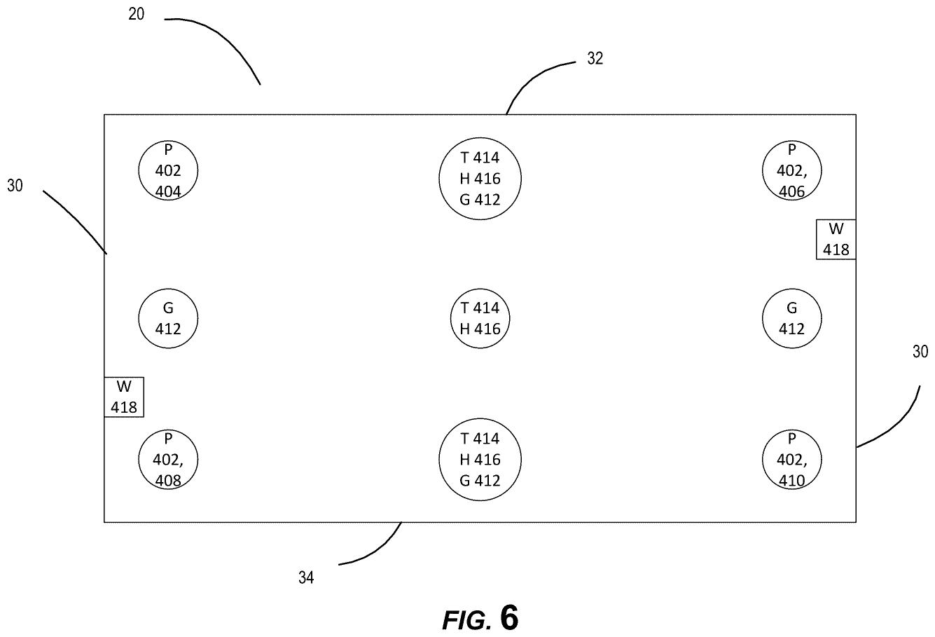

FIGS. 6 through 12 illustrate the use of sensor(s) 400, hub(s) 450, and/or light device(s) 470 within the insulated panel 22 (e.g., on or inside the panel 22, visible or non-visible, or the like). As illustrated in FIG. 6, in some embodiments a plurality of sensors 400 may be operatively coupled to one or more of the panel substrates 24, 26, or otherwise located within the insulation material 50.

In some embodiments, the one or more sensors 400 may comprise one or more pressure sensors 402. In some embodiments, the one or more pressure sensors 402 may be a first pressure sensor 404 located adjacent a first panel corner, a second pressure sensor 406 located adjacent a second panel corner, a third pressure sensor 408 located adjacent a third panel corner, and a fourth pressure sensor 410 located adjacent a fourth panel corner. However, it should be understood that the one or more pressure sensors 402 may be located anywhere adjacent the ends 30, 32 and/or edges 34, 36 of the insulated panel 22. Moreover, it should be understood that the one or more pressure sensors 400 may be located at any location between the ends 30, 32 and/or edges 34, 36 of the insulated panel 22. The one or more pressure sensors 402 are configured to indicate structural changes in the insulated panel 22, a structure 1, and/or support members 12 on which the insulated panel 22 is installed. As such, while the one or more pressure sensors 402 may be located in any location on the panel 22 it may be beneficial to locate the one or more pressure sensors 400 adjacent the locations at which the insulated panels 22 are operatively coupled to the support members 12 of the structure 1. As such, the one or more pressure sensors 402 may send signals regarding the pressure and/or changes in the pressure at the location of the one or more pressure sensors 402, which may be utilized to determine structural changes in the insulated panel 22, the one or more support members 12, and/or the structure 1. Moreover, when multiple pressure sensors 402 are utilized in multiple panels 22 within the building envelop system 10, multiple readings from the pressure sensors 402 may be analyzed in combination in order to determine changes in the building envelope system 10 and/or the structure 1. As such, the one or more pressure sensors 402 may be used to monitor changes in the structure 1 over time (e.g., hours, days, weeks, months, years, decades, or the like).

Additionally, or alternatively, the one or more sensors may be one or more position sensors that provide absolute position or relative position. As such, in some embodiments of the disclosure, the one or more position sensors may be placed adjacent the ends 30, 32 and/or edges 34, 36 (or both) of the insulated panels 22. However, like the one or more pressure sensors 402, the one or more position sensors may be located anywhere on the insulated panel 22. The one or more position sensors may include time-of-flight (ToF), such as a laser (scanning or scannerless LIDAR, or the like), LED, other light, or the like sensors. The ToF sensors may utilize RF-modulated light source (e.g., photonic mixer devices (PMD)), range gated imagers, direct ToF imagers, or the like. As such, in some embodiments the ToF sensors may be used with surfaces that are reflective (e.g., the surfaces of the panels 22 themselves, elements within the structure that by their nature are reflective, the structure 1 itself or the like) and/or reflectors may be located on the panels 22, on other elements within the structure 1, on the structure 1 itself, or the like. As such, the ToF sensors may utilize reflective material to determine movement between the panels, the structure 1, and/or elements within the structure 1. Other types of position sensors may include capacitive displacement sensors, inductive sensors, laser doppler vibrometer (LDV), proximity sensor, accelerometer, infrared (IR) sensors, or the like. The one or more position sensors, like the pressure sensors, may be used to determine changes in the building envelope system 10, the structure 1, and/or the elements within the structure 1. As such, the one or more position sensors may be used to monitor position changes in the structure 1 over time (e.g., hours, days, weeks, months, years, decades, or the like). For example, the one or more position sensors may be utilized to detect small structural malforming and/or other anomalies (e.g., between walls, roofs, floors, support members 12, equipment, or the like) that might develop over time in the structure 1, elements within the structure 1, and/or the panels 22.

Furthermore, the one or more position sensors may be used to analyze elements within the structure 1, such as cranes, crane rigging, forklifts, robotic equipment (e.g., manufacturing robots, transport robots, storage robots, or the like), other equipment, material coupled to the cranes, rigging, forklift, robotic equipment, or other equipment, and/or movement of people within the structure. For example, the one or more position sensors may be utilized to analyze these elements within the structure 1 to determine usage of these elements (e.g., normal, potentially abnormal, abnormal, or the like). In some embodiments, alerts (e.g., notifications, e-mails, lights-such as emergency flashing lights, sounds-such as emergency sounds, or the like) may be sent regarding the usage of the elements within the structure 1. In other embodiments, the systems operating within the structure, as will be described in further detail, may be utilized to at least partially control the elements being monitored (e.g., adjust the equipment, stop the equipment, provide recommendations for operation of the equipment, or the like).

Additionally, or alternatively, one or more location sensors (e.g., global positioning system (GPS), satellite trackers, RFID communication, location tagging, or the like). As such, the one or more location sensors may be included in each panel 22. As such, the location from which data is being received may be determined from the one or more location sensors. However, in other embodiments, the one or more location sensors (e.g., within a user computer system 320, such as a mobile device, as will be discussed in further detail) may be external sensors that are used to log the location of the panel 22 as it is installed. For example, an initial position of a first panel 22 may be logged, as well as each subsequent location of each panel (e.g., independently or with respect to the first panel, another panel, and/or an adjacent panel). As such, regardless of the one or more location sensors are permanently or temporarily operatively coupled to the panels 22, the location of the panels 22 (e.g., sensors 400, hubs 450, light devices 470, or the like thereof) for the structure 1 may be determined in order to determine the location of the panels 22 and/or sensors 400, hubs 450, and/or light devices 470 within the insulated panel 22 and/or from where data is being received. Consequently, when data is collected from the panel 22 (e.g., sensors 400, hubs 450, and/or light devices 470 thereof) the position of the panel 22 (or components thereof) may be used to determine from which panel 22 the data is being received.

Additional, or alternatively, one or more vision sensors (e.g., cameras-still images, video images, lasers, LIDAR, radio, infrared, or the like) may be included within the one or more panels 22. As such, similar to the one or more position sensors, the one or more vision sensors may be used analyze elements within the structure 1, such as cranes, crane rigging, forklifts, robotic equipment (e.g., manufacturing robots, transport robots, storage robots, or the like), other equipment, material coupled to the cranes, rigging, forklift, robotic equipment, or other equipment, and/or movement of people within the structure 1. Alternatively, or additionally, the one or more vision sensors may be used to monitor and/or authenticate elements (e.g., equipment, people, or the like) within the structure 1. For example, monitoring elements (e.g., equipment, people, or the like) within the structure 1 may allow for optimizing of movement within the structure (e.g., improved processing, manufacturing, flow of elements, or the like). In other examples, authentication of the elements (e.g., for access to different areas of the structure, or the like) may be used to allow and/or prevent elements within the structure 1 from accessing different restricted areas of the structure 1. As such, the monitoring and/or authentication of the elements may provide improved efficiency, improved identification of potential safety and/or security issues, or the like. The one or more vision sensors, like the one or more position sensors, may be used to capture data and provide notifications when the one or more vision sensors identify an anomaly and/or for optimization of the operation of the structure or the elements therein.

Additionally, or alternatively, one or more gas sensors 412 may be utilized within the panels 22 in order to determine if there is a potential fire, chemical event, or other gas release. As such, in some embodiments of the disclosure the one or more gas sensors 412 may be placed adjacent the ends 30, 32 and/or edges 34, 36 (or both at the corners) of the insulated panels 22. However, like the one or more pressure sensors 402, the one or more gas sensors 412 may be located anywhere on the insulated panel 22. As such, the one or more gas sensors 412 may send signals regarding the presence of a certain gas and/or particulate matter (e.g., smoke, dust, or the like), which may indicate the presence of a fire in the structure, or other type of event involving gas (e.g., gas leak, chemical leak, or the like). To do so, the one or more gas sensors 412 may use ionization chamber, sensors such as photoelectric detection, optical, electrochemical, metal oxide semiconductor, optochemical, or the like, spectroscopy, and so forth.

Additionally, or alternatively, one or more temperature sensors 414 may be used in order to determine the temperature of the insulated panel 22, outside of the insulated panel 22 (e.g., exterior side of the panel), inside of the insulated panel 22 (e.g., interior side of the panel), between adjacent insulated panels 22, within the insulation material 50 of the insulated panels 22, and/or combinations thereof. The one or more temperature sensors 414 are illustrated as being located adjacent the edges 34, 36 and/or adjacent the center of the insulated panel 22. However, it should be understood that the one or more temperature sensors 414 may be located anywhere on the insulated panel 22. The one or more temperature sensors 414 may serve various functions. For example, the one or more temperature sensors 414, like the gas sensors 412, may be used indicate the presence of a fire. However, in other embodiments the one or more temperature sensors 414 may be used to indicate an issue with the insulated panel 22, such as a defect in the insulated panel 22, an issue with the operation of the building envelope system 10 (e.g., not operating as designed, or the like), an issue with a climate control system of the structure (e.g., heating or cooling systems not operating in one or more areas of the building, or the like).

Additionally, or alternatively, one or more humidity sensors 416 (e.g., hygrometers) may be used in order to determine the humidity of the insulated panel 22, outside of the insulated panel 22 (e.g., exterior side of the panel), inside of the insulated panel 22 (e.g., interior side of the panel), between adjacent insulated panels 22, and/or combinations thereof. In some embodiments, the one or more humidity sensors 416 may be utilized to identify an issue with a panel 22 and/or structure 1, such as excessive fluid (e.g., water, or the like) within the insulated panel 22 (e.g., in the insulation material 50), within the building envelope system 10, and/or within locations of the structure (e.g., indicating a leak in plumbing, in a roof, within the building envelope system 10, or the like). In addition to, or in place of the one or more humidity sensors 416, one or more liquid sensors (e.g., water sensors, or the like) may be used to detect the presence of liquid adjacent the panels 22 (e.g., within, around, near, or the like).

Additionally, or alternatively, one or more air flow sensors 418 may be used in order to determine the air flow adjacent an insulated panel 22, outside of the insulated panel 22 (e.g., exterior side of the panel), inside of the insulated panel 22 (e.g., interior side of the panel), between adjacent insulated panels 22, and/or combinations thereof. The one or more air flow sensors 418 may aid in identifying air flow adjacent to the insulated panel 22 and/or between adjacent insulated panels 22 in order to identify potential issues with the structure 1 (e.g., defects in the envelope of the structure 1 through which air is escaping or entering, issues with the heating and/or cooling of the structure 1). Additionally, or alternatively, the air flow sensors 418 may be utilized for climate control of the structure (e.g., providing data to inform a change in the heating, cooling, and/or airflow speeds in different locations of the building, or the like).

Additionally, or alternatively, the one or more sensors 400 described herein may be used to detect the potential weather events that may require altering the operation of the structure 1, such as closing or opening barriers (e.g., doors, roofs, windows, or the like) in the structure 1, altering the climate control (e.g., heating, cooling, or the like), deactivating or activating equipment, closing the facility, or the like.

Additionally, or alternatively, one or more vibration sensors (e.g., accelerometers or the like) may be utilized to detect vibrations within the insulated panel 22, adjacent to the insulated panel 22 (e.g., on the exterior or interior side of the panel), between adjacent insulated panels 22, and/or within the structure 1. In some embodiments, the vibration sensors may help detect issues such as structural instability or excessive vibration caused by environmental factors (e.g., wind, seismic activity, machinery operation, or the like). The vibration sensors may also detect irregularities in mechanical systems housed within or near the structure to identify malfunctions such as unbalanced rotating equipment, worn components, or the like.

Additionally, or alternatively, one or more sound sensors (e.g., microphones, acoustic sensors) may be used to monitor sound levels and patterns in the vicinity of the insulated panel 22, on either the exterior or interior side of the panel, or between adjacent insulated panels 22. The sound sensors may detect abnormal noise levels that could indicate mechanical issues, such as equipment malfunctions, environmental problems, such as leaks or cracks that permit external noise to enter the building, or the like, unauthorized access or breaches in security, or the like.

Regardless of the type, number, and/or location of the sensors 400 (e.g., on the substrates, within the insulation materials, adjacent the ends, edges, center, or on the ends, edges or the like) the sensors 400 alone or in combination may be used to identify issues in the insulated panels 22, the building envelope system 10, the support members 12, the structure 1, elements within the structure, or the like, and/or may aid in controlling the operation of the structure 1 (e.g., controlling the climate control systems).

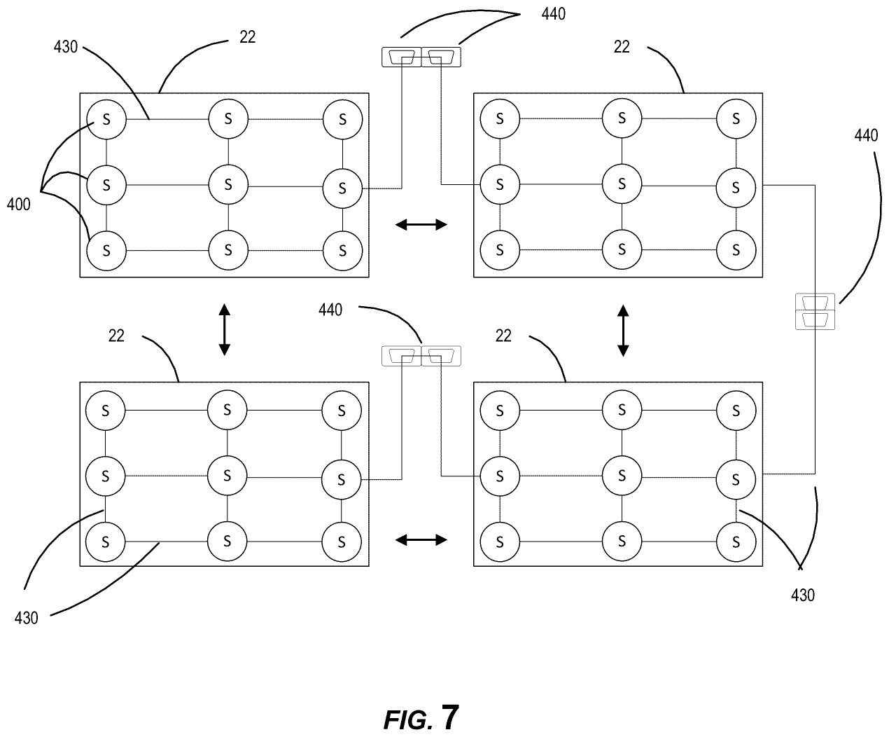

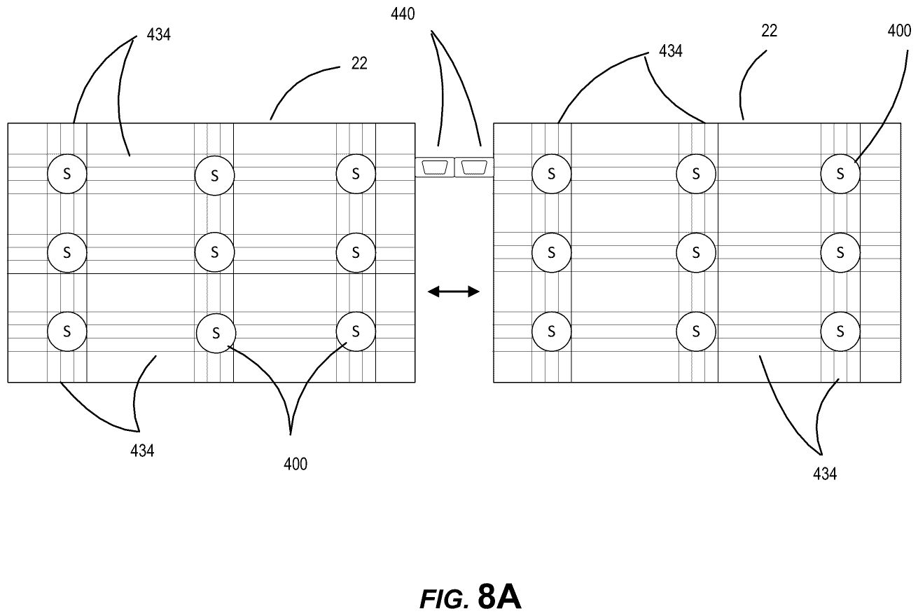

In some embodiments of the disclosure, the one or more sensors 400 may be operatively coupled to each other (or to a panel hub 450) through the use of wireless and/or wired connections 430, as illustrated in FIG. 7. Moreover, adjacent panels 22 may be operatively coupled through the use of electrical connectors 440 (e.g., USB, wire-to-wire connectors, wire-to-board connectors, wire terminals, terminal blocks, circular connectors, pin connections, lighting connectors, keyed connectors, inductive coupling, capacitive coupling, or the like). In some embodiments, the wired connections 430 may be operatively coupled to the first substate 24 and/or second substrate 26 and/or may be at least partially secured within a wire housing 432. The wire housing 432 may be any type of housing made of any material (e.g., plastic, such as PVC, polyethylene, polypropylene, or the like, other types of material) and/or made of any shape (e.g., circular, oval, square, rectangular, any polygon, uniform, non-uniform, or the like shape). In some embodiments, the wire housing 432 may be made, at least partially, from insulative material in order to maintain the insulative properties of the insulated panel 22. In some embodiments, the one or more sensors 400 may be operatively coupled to each other (or to a panel hub 450) through the use of a databus (BUS), which may be an architecture that allows for communication between sensors 400 and/or hubs 450 through hardware (e.g., wired, wireless, or the like) and/or software components (e.g., protocols, or the like), as will be described in further detail herein. As such, in some embodiments data, power, or the like may be transferred between sensors and/or between hubs through the use of wired (e.g., a single wire, multiple wires, or the) and/or wireless connections through the BUS and/or other networked components.

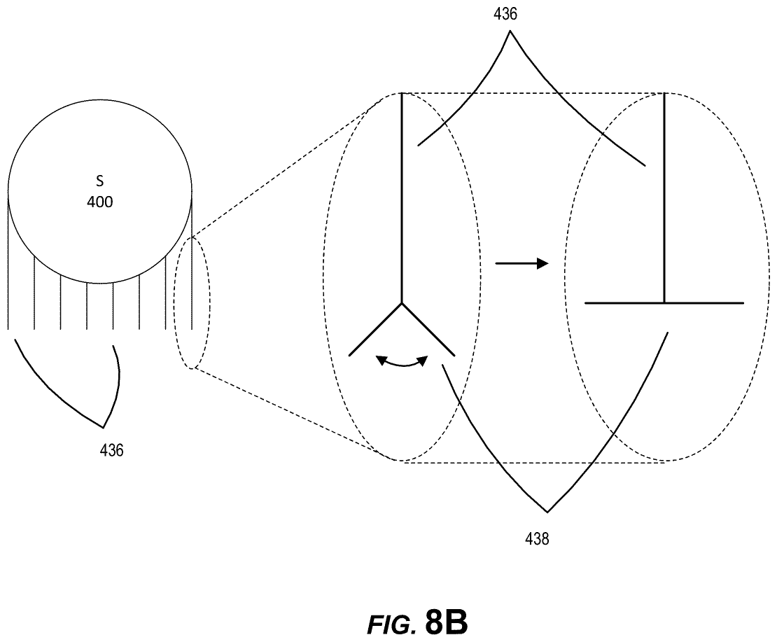

In some embodiments, as illustrated in FIG. 8A, instead of, or in addition to, using wireless, wired connections 430, and/or electrical connectors 440 to operatively couple the insulated panels 22, a circuit 434 may be provided on a surface of the first substrate 24 and/or the second substrate 26. The circuit 434 may be an electrical circuit that is formed on the surface of the substrate 24, 26. It should be understood that forming the circuit 434 directly on a surface of the insulated panel 22 may allow for improved placement and/or flexibility in the placement of the sensors 400. Forming the circuit 434 directly on the substrate 24, 26, may remove the need to run the wires between sensors 400 and/or secure the wires 430 within the insulated panel 22 (e.g., in a wire housing 432, or the like). Moreover, forming the circuit 434 directly on the substrate 24, 26 may allow for the use of continuous panel manufacturing through the use of applying the circuit 434 and/or the sensors 400 in-line after the substrates are formed (e.g., unwound, rolled, or the like) and before the unexpanded insulation material 52 is applied to at least one of the substrates 24, 26. For example, the circuit 434 may be printed onto the substrate 24, 26, may be applied through the use of a film, may be sprayed, etched, and/or applied through other installation processes.

FIG. 8B illustrates that in some embodiments, the sensors 400 may include one or more pins 436 having one or more anchor locks 438. In some embodiments, the pins 436 may be secured to the circuit 434 by inserting the pin into the circuit 434 (e.g., aperture located in the circuit, or the like) and the anchor lock 438 that may move (e.g., one or more legs that may bend, spring, be biased, or the like) to hold the one or more pins 436, and thus, the sensors 400 in place as the insulation material 50 is applied and expands. However, in other embodiments the sensors 400 may be operatively coupled to the circuit 434 through the use of any type of material (e.g., adhesives, epoxy, caulk, mastic, tape, or the like) and/or fasteners (e.g., mechanical fasteners, such as screws, bolts, rivets, or the like, welds, solder, or the like) that maintain the connection with the circuit.

In some embodiments, the connectors 440 may be wired connectors or may be integral within the circuit. For example, the connectors 440 may be integral with the ends 30, 32 and/or edges 34, 36 of the insulated panels 22 such that when adjacent insulated panels 22 are butted against each other at the ends 30, 32 and/or edges 34, 36, the electrical connectors 440 may contact each other, and thus completing the circuit between adjacent panels 22. For example, surface to surface connections between the surfaces of adjacent panels 22 may be result in a connection between the panels. In some embodiments, the connections may be localized and/or biased (e.g., spring-loaded, displaceable, or the like) such that when localized connectors 440 touch they maintain contact even when adjacent panels 22 do not touch (e.g., due to tolerances, settling over time, or the like). Alternatively, as described herein the connectors 440 may require plugging into each other and secured within the ends 30, 32 and/or edges 34, 36 to hide the connectors 440 and/or wires 430 thereof.

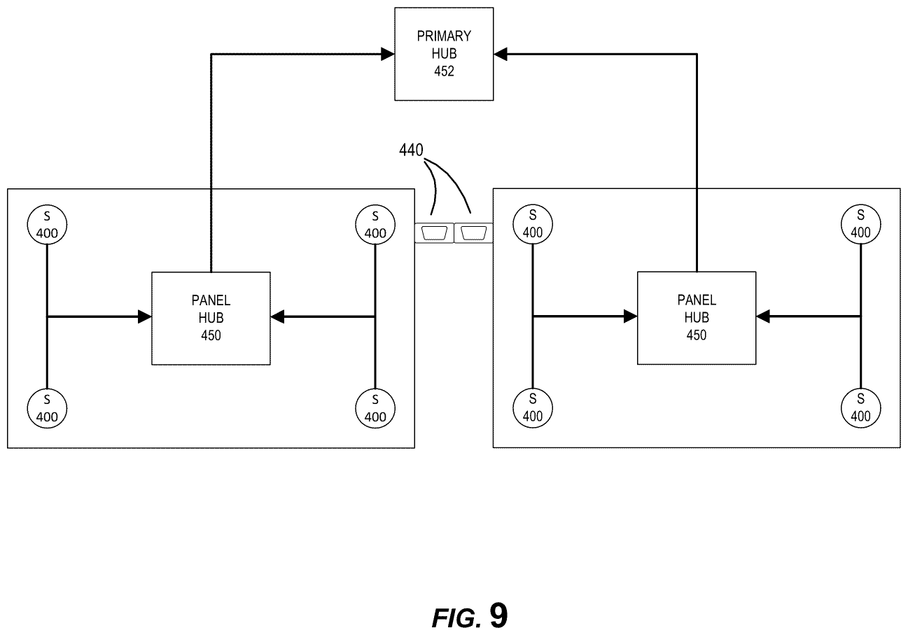

FIG. 9 illustrates embodiments of the present disclosure in which panel hubs 450 are utilized within two or more insulated panels 22 and operatively coupled to a primary hub 452 (e.g., through a wired, wireless, or the like connection), in order send and/or receive information between the sensors 400, panel hub 450, and/or the primary hub 452. It should be understood that the panel hubs 450 may comprise one or more processors, one or more memories, one or more communication devices, one or more datastores, and/or the like. In some embodiments, the panel hubs 450 may be motherboards. The panel hubs 450 and/or the sensors 400 (e.g., directly, indirectly through the hubs 450, or the like) may be powered by battery power, solar power (e.g., in the panels or from other sources), wired power, wireless power, or the like.

One or more computer BUSs may be utilized to allow for communication between the panel hubs 450, primary hub 452, sensors 400, and/or light devices 470. The one or more computer BUSs may have wired or wireless communication that carry signals (e.g., data) between the components of the insulated panels 22 and/or components thereof (e.g., using data modulation at the transmitter and/or receiver), thus allowing for the components to communicate with each other, provide power to each other, and/or control the flow of the data and/or power. As such, the BUSs may have communication repeaters (e.g., for amplifying data or power transmission), switches (e.g., allowing for communication between certain sensors 400, hubs 450, and/or the like), bridges (e.g., for connecting the sensors 400, hubs 450, and/or the like to a network), or the like that aid the operation of the BUSs.

It should be understood that in some embodiments, the hubs 450 and/or sensors 400 (e.g., directly, indirectly through the hubs 450, or the like) may be powered by a low voltage power supply, such as 1, 2, 3, 4, 5, 6, 7, 8, 9, 10, 12, 15, 17, 20, or the like voltages, and in particular, using 5V low voltage power supply. In the event wireless power is utilized, the wireless power may occur through the transfer of power through near-field power transfer (e.g., magnetic fields, inductive coupling, electric fields-capacitive coupling, or the like) or far-field power transfer (e.g., through beams of electromagnetic radiation, such as microwaves, radio waves, lasers, infrared, visible light waves, or the like). Wireless power may include the use of a transmitter that is connected to a source of power (e.g., wired grid power, solar power, turbine power, wind power, gas power, or the like) and a receiver (e.g., that receives the power and converts it to AC, DC, or other useable power).

It should be understood that every insulated panel 22 may have a panel hub 450, however, in other embodiments, a panel hub 450 may be located in a single hub 450 but may send or receive signals from sensors 400 in different panels 22 (e.g., through the electrical connectors 440, wireless communication, or the like). In some embodiments, the primary hub 452 may have processors, memories, communication devices, one or more datastores, and/or the like. As such, the primary hub 452 may be any type of computer system, but in particular embodiments may be servers that are located locally and/or remotely, such as cloud systems.

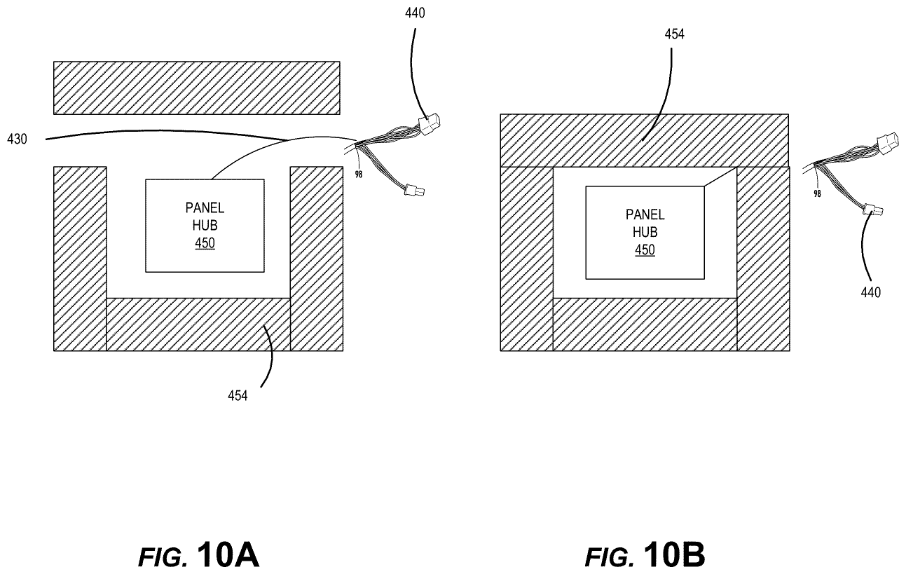

The panel hubs 450 may require protection from the insulation material 50 during and/or after the insulation material 50 is applied to the substrates 24, 26. As such, in some embodiments the panel hubs 450 may be secured within a panel hub housing 454. FIGS. 10A and 10B illustrate cross sectional views of the panel hub housing 454 in accordance with some embodiments of the present disclosure. It should be understood that the panel hub housings 454 may be made from any type of material (e.g., plastic, metal, composites, carbon fiber, or the like), have any type of shape (e.g., circular, oval, square, rectangular, any polygon, uniform, non-uniform, or the like shape), and/or have any number of components (e.g., a base, walls, covers, or the like). In particular embodiments, the panel hub housing 454 may be made of insulation material (e.g., the same, similar, or different insulation material used within the insulated panel 22). As such, the panel hub housing 454 with the panel hub 450 located therein will be operatively coupled to a substrate 24, 26 during manufacturing of the panel, as will be described in further detail herein.

In some embodiments, a portable computer device may be operatively coupled to a panel 22 in order to capture data and/or power components within the panel 22. In some embodiments, the portable computer device may by any type of computer system (e.g., smartphone, or the like as will be discussed in further detail herein) or may be any device that can receive and/or transmit data and/or power to and/or from the sensors 400 and/or hubs 450. In some embodiments, the portable computer device may communicate with the sensors 400 and/or hubs 450 through the use of any communication described herein (e.g., wired and/or wireless communication, such as near field communication (NFC), radio, cellular, WiFi, Bluetooth, RFID, mesh, microwave, infrared, or the like). As such, in some embodiments, the portable computer device may be required to have wired connection to one or more sensors 400 and/or hubs 450; however, the portable computer device may merely need to be located adjacent (e.g., with yards, feet, inches, or the like) to one or more sensors 400 and/or hubs 450 in order to transfer data and/or power. In some embodiments, the portable computer device may be held up to a panel 22 and/or operatively coupled to a panel 22 (e.g., through one or more magnets, or the like) at or near the one or more sensors 400 and/or the hubs 450. Once communication is established between the portable computer device and the one or more sensors 400 and/or hubs 450, the portable computer device may receive information from, or transfer information to, the one or more sensors 400 and/or hubs 450, and/or receive power from, or transfer power to, the one or more sensors 400 and/or hubs 450.

As will be described in further detail below, it should be understood that the data from the one or more sensors 400 and/or hubs 450 described above may be used to create customized modules for the specific structure 1 and/or elements within the structure 1, for detection of anomalies thereof, detection of the functions thereof based on internal and/or external events, determination of optimized operation of thereof, determination of power needs for operation thereof (e.g., cooling, heating, lighting, or the like), or other operation of the structure 1 and/or elements therein. In some embodiments, machine learning and/or artificial intelligence may be utilized in order to create the customized modules, as will be described in further detail below.

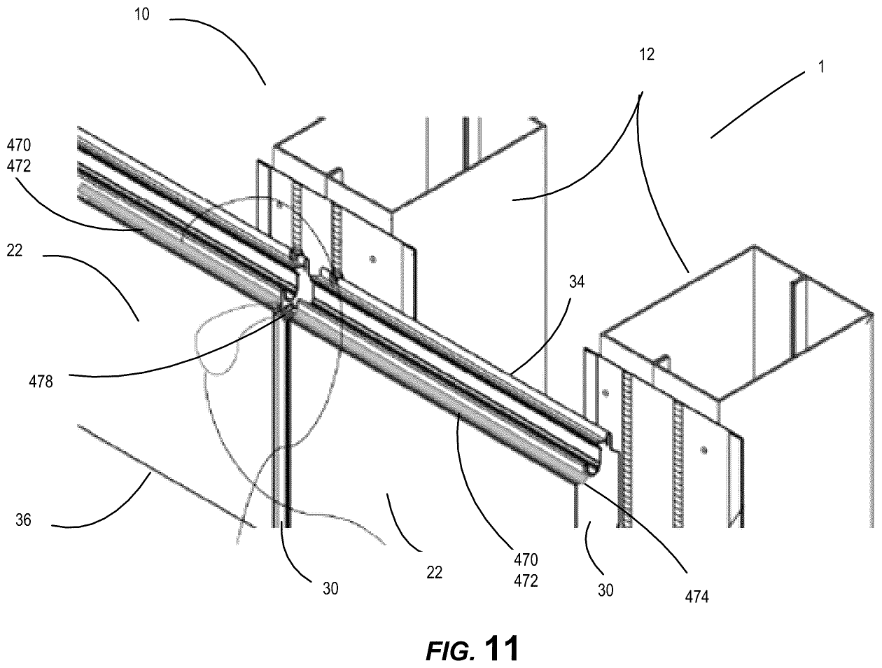

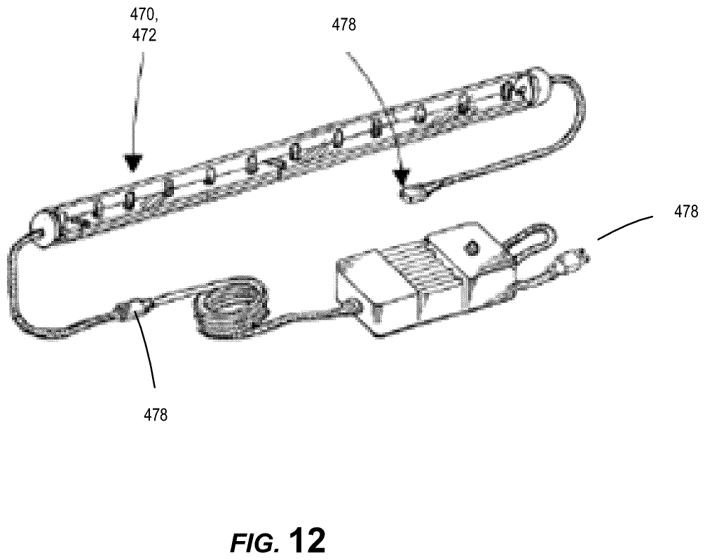

FIGS. 11 and 12 illustrate the use of a light device 470 within the insulated panel 22. The light device 470 may be any type of light, such as light emitting diode (LED), halogen, compact fluorescent lamps (CFL), fluorescent lamps, incandescent bulbs, or any other type of light; however, in particular applications, the light device 470 is an LED light or a plurality of LEDs. The light device 470 may be included in different locations and/or include different colors such that the different color lights in different locations may be activated and deactivated individually and/or as a group in order provide different lighting. In some embodiments, the light devices 470 may be positioned for exterior lighting on the outside of the insulated panel 22. However, additionally, or alternatively, the light devices may be positioned for interior lighting on the inside of the insulated panel 22. That is, in some embodiments, the lighting devices 470 may provide lighting to an open space on the inside of the building envelope system 10 directly or through a partition (e.g., glass, or other transparent, partially transparent, opaque, or the like other material). Incorporating the light devices 470 within the insulated panels 22 provides optionality for lighting the exterior and/or interior of a structure 1, reduces costs by eliminating stand-alone lighting configurations and/or lighting configurations integrated in other components of the structure 1, which are installed before, during, or after the insulated panels 22 are installed on the structure 1. The operation of the light devices 470 will be described in further detail herein.

As illustrated FIGS. 11 and 12, in some embodiments of the present disclosure, the light device 470 may be in the form of a light strip 472 that is located on the edges 34, 36 of the insulated panels 22. For example, in some embodiments, a channel 474 is located on the edges 34, 36 of the insulated panels 22 for receiving one or more light devices 470. While the light device 470 is illustrated as being located on the edges 34, 36 of the insulated panels 22 it should be understood that the light device 470 may be located in any area of the panels 22, such as the ends 30, 32, any location on a substrate 24, 26 adjacent the ends 30, 32 and/or the edges 34, 36, and/or any location between the ends 30, 32 and/or the edges 34, 36 (e.g., any location near or at the center of the substrate, along a central axis of the substrate, or the like). When located in the substrate 24, 26, a channel 474 or another aperture (e.g., a circle, oval, square, rectangle, any polygon, uniform, non-uniform, or other like shape may be formed (e.g., rolled, cut, punched, pressed, or like, or combinations thereof) within one or more locations within the substrate 24, 26. This may be performed in-line for continuous manufacturing, or during or creation of the substrate 24, 26 for discontinuous processing. Moreover, like the sensors 400 and/or panel hubs 450 previously described herein, a light connector (e.g., plug, UBS, or other type connector, and/or a socket or other connection used to receive a light device 470) may be operatively coupled the first substrate 24 and/or the second substrate 26 before, during, or after the unexpanded insulation 52 is provided to the first substrate 24 and/or second substrate 26 and allowed to expand and cure into the insulation material 50. The light devices 470, or a portion thereof may include a light housing, which like the panel hub housing, protects the sensitive portions of the light devices during the manufacturing process. As such, the locations of the light device 470 may be pre-determined and, in some embodiments, at a least a portion of the light device 470 and/or a light connector 478 therefor may be formed within a portion of the insulated panel 22. It should be understood that the light devices 470 may be powered in the same or similar way as the sensors 400, the panel hubs 450, or the like. However, in some embodiments the light devices 470 may have their own power supply (e.g., due to increased or decreased power requirements for the light devices 470, or the like). As such, in some embodiments, the light devices 470 may be powered through the use of the power supply to the panel hub 450. In other embodiments, the light devices 470 may have a separate power supply within the insulated panel 22 or outside of the insulated panel 22 from the structure 1, or other location thereof. However, it should be understood that the light devices 470, as previously described with respect to the sensors 400 and/or hubs 450, may be powered through the use of wired and/or wireless communications.

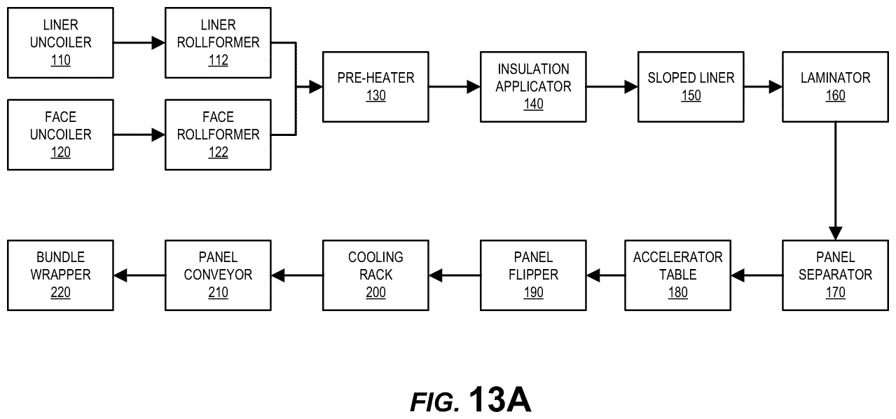

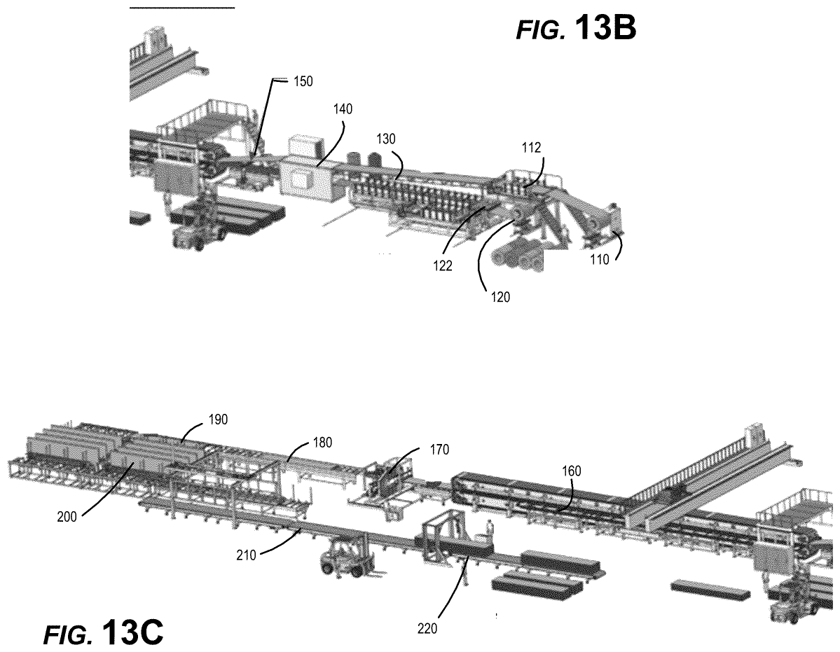

It should be understood that the insulated panels 22 having sensors 400, panel hubs 450, and/or light devices 470 may be utilized in different types of panel forming equipment and/or processes. However, in particular embodiments the processing equipment may be continuous processing equipment or foamed in place discontinuous processing equipment. FIGS. 13A through 13C illustrate one type of insulated panel manufacturing equipment 100 and process of manufacturing the insulated panels 22. As illustrated, the insulated panel 22 may be formed through the use of an upper uncoiler 110 (e.g. liner uncoiler, or the like), which may uncoil a steel roll and an upper rollformer 112 (e.g., a liner rollformer, or the like) may roll the steel sheet into the desired shape for an upper substrate (e.g., including in some embodiments the apertures for the one or more light devices 470). Moreover, a lower uncoiler 120 (e.g., face uncoiler, or the like) may uncoil a steel roll and a lower rollformer 122 (e.g., a face rollformer, or the like) may roll the steel sheet into the desired shape for the lower substrate (e.g., including in some embodiments the apertures for the one or more light devices 470). It should be understood that the upper equipment and the lower equipment may form either of the first substrate 24 or the second substrate 26 depending on the equipment and process being used.

While not specifically illustrated in FIGS. 13A through 13C, the wired connections 430, the wire housings 432, and/or circuit 434 may be operatively coupled to the first substrate 24 and/or the second substrate 26. Moreover, while not specifically illustrated in FIGS. 13A through 13C, the one or more sensors 400, the panel hubs 450, and/or at least a portion of the light devices 470 may be operatively coupled to the first substrate 24 and/or the second substrate 26, as previously discussed herein.

As further illustrated in FIGS. 13A through 13C, a pre-heater 130 may be utilized in order to heat one or more of the substrates 24, 26 for depositing of the unexpanded insulation 52 (e.g., the liquid insulation 54 or the foam insulation 54) onto one of the substrates 24, 26.

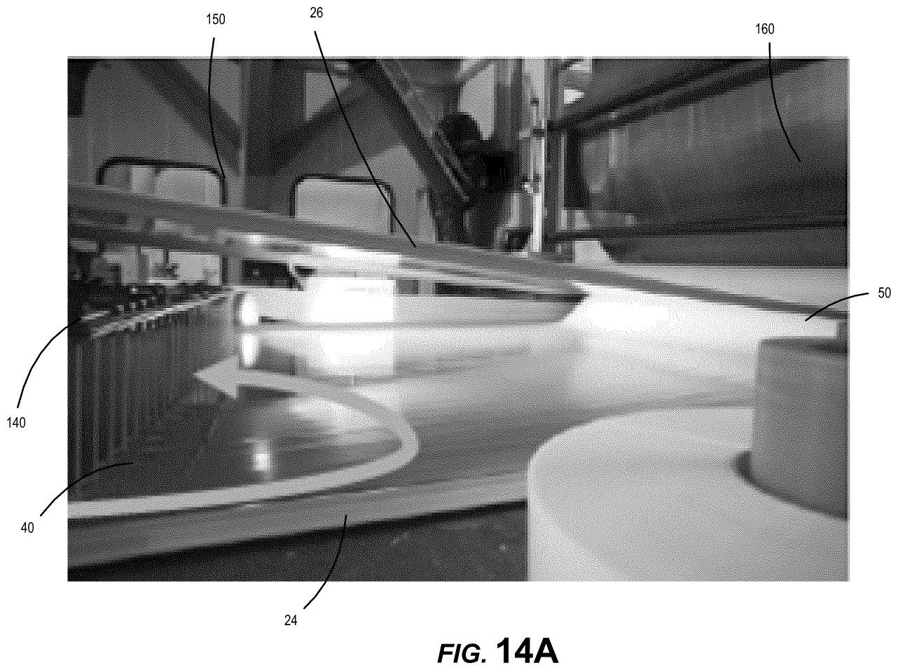

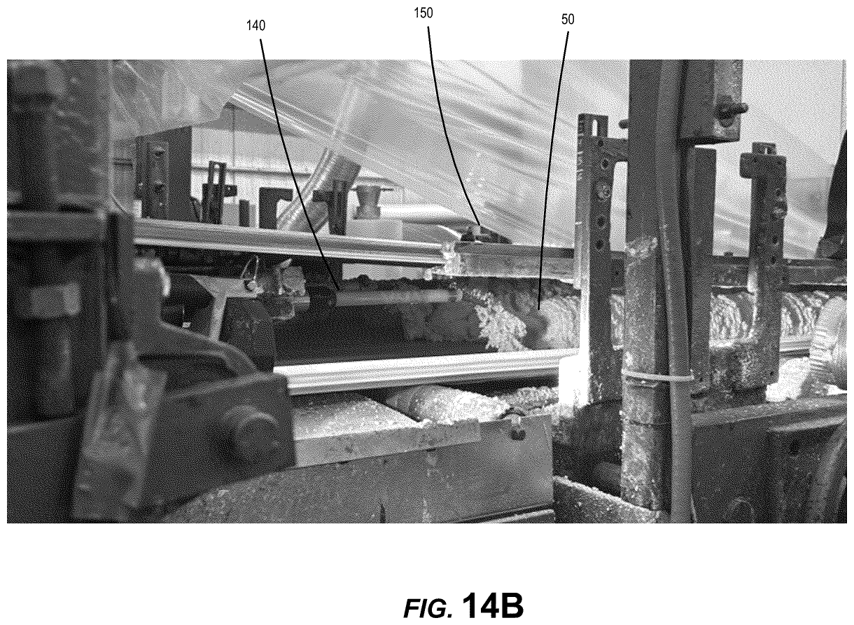

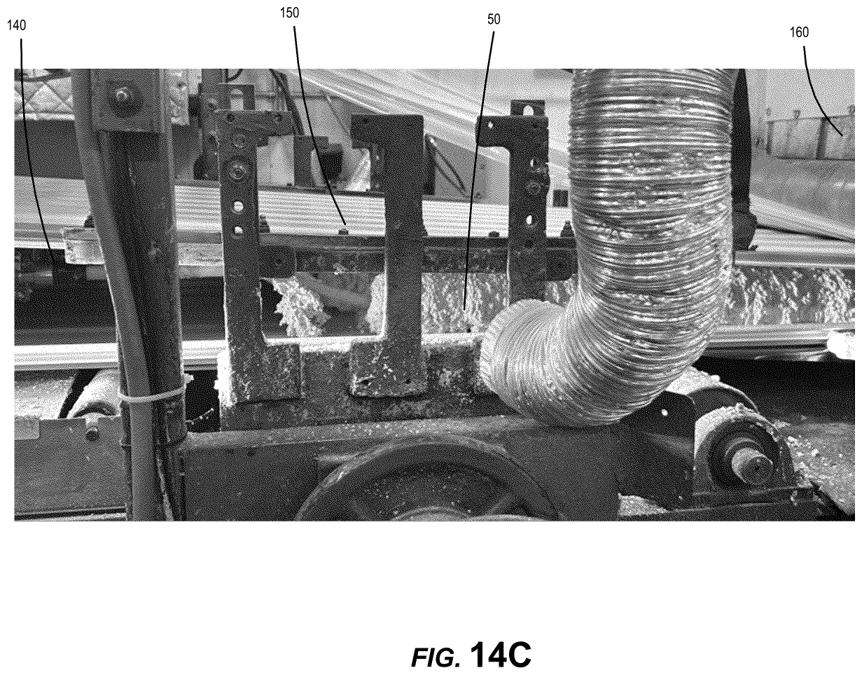

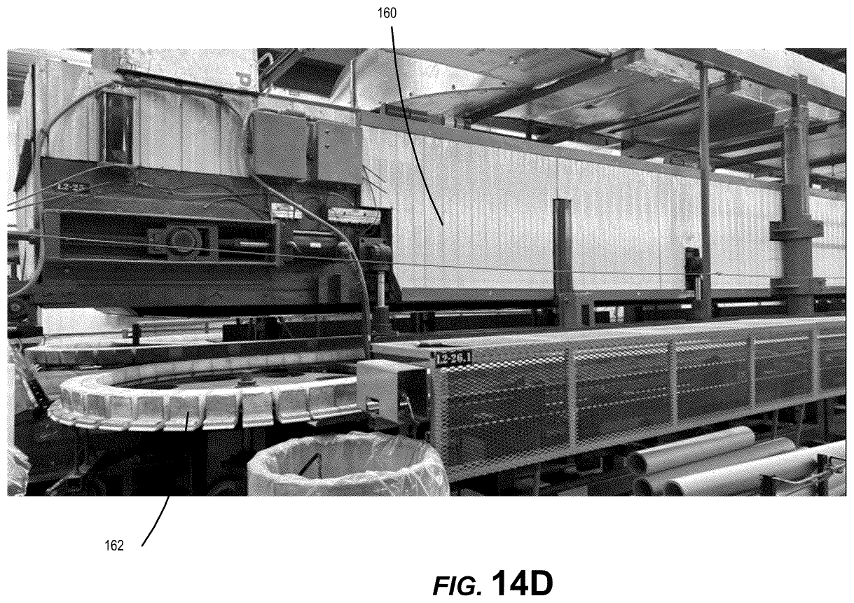

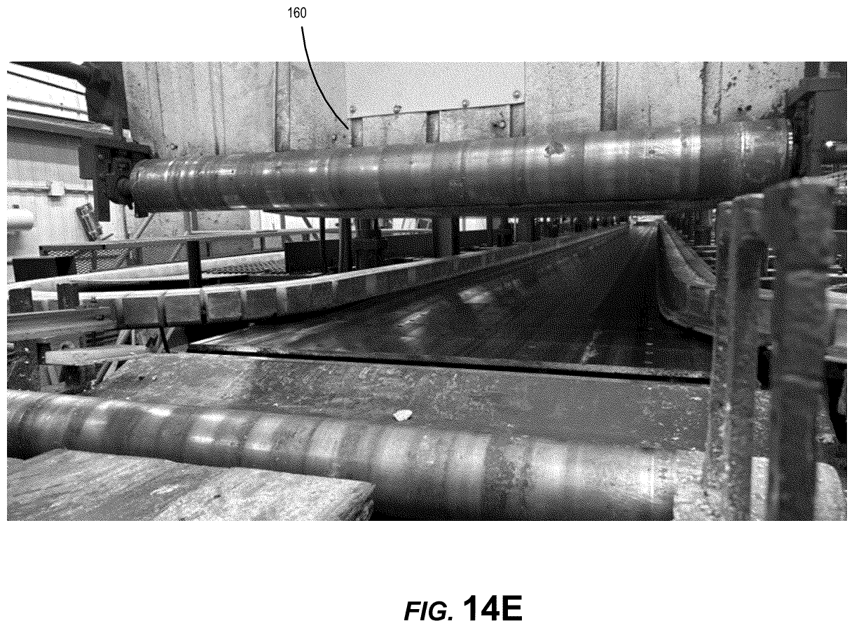

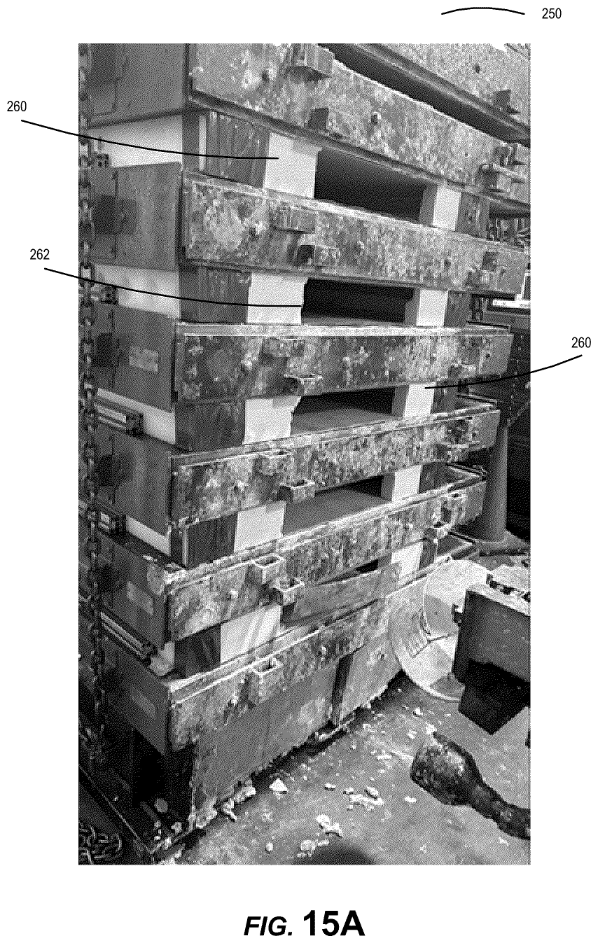

As further illustrated in FIGS. 13A through 13C, the insulation applicator 140 applies the unexpanded insulation material 52 in a liquid form, as illustrated in FIG. 14A, or in a foam form, as illustrated in FIG. 14B. In the illustrated embodiment in FIG. 14A, the insulation applicator 140 comprises of a plurality of liquid dispensing nozzles that are stationary and that deposit the unexpanded insulation material 52 (e.g., liquid) over at least a portion of one of the substrates, such as the first substrate 24. As the first substrate 24 and the second substrate 26 move down the line toward the laminator 160, which will be described in further detail here, the insulation material may expand between the first substrate 24 and the second substrate 26. In alternate embodiments, as illustrated in FIG. 14B, the insulation applicator 140 may apply the unexpanded insulation material 52 as expanding foam insulation 54. In this embodiment one, two, three, four, or the like foam nozzles dispense the expanding foam insulation 54 onto on the substrates, such as the first substrate 24. As the first substrate 24 and the second substrate 26 move down the line toward the laminator 160, the insulation material begins to expand between first substrate 24 and the second substrate 26. As further illustrated in FIGS. 13A through 13C, the sloped liner entry 150 directs the second substrate 26 towards the laminator 160 to be laminated with the expanding insulation material 50 and the first substrate 24.

The laminator 160, as illustrated in FIGS. 13A through 13C, uses heat and/or pressure to laminate the first substrate 24, the expanding insulation material 50, and the second substrate 26 into the insulated panel 22. Moreover, the laminator 160 may have molds 162 at the edges of the first substrate 24 and the second substrate 26 that aid in forming the edges 34, 36 of the insulated panel 22 (e.g., the projections 40 and the cavities 42 formed by the projections 40) and/or restricting the expanding insulation material from foaming outside of the envelope of the insulated panel 22 onto unintended locations of the laminator 160.

After the insulated panel 22 is formed, the panel separator 170 (e.g., saw, cutter, blade, knife, laser, plasma, or the like) may be used to separate the insulated panel 22 exiting the laminator 160 into the desired lengths, and thus forming the ends 30, 32 of the individual insulated panels 22. After separating, the accelerator table 180 may be used to speed up the movement of the separated panels 22 towards the next station, such as the panel flipper 190, cooling rack 200, and/or other station, where the panels 22 are allowed to fully cure. After the panels 22 have fully cured and cooled, the panel flipper 190 and/or panel conveyor 210 may move the panels 22 toward a bundle wrapper 220 for packaging the panels 22 before they are shipped to the customer.

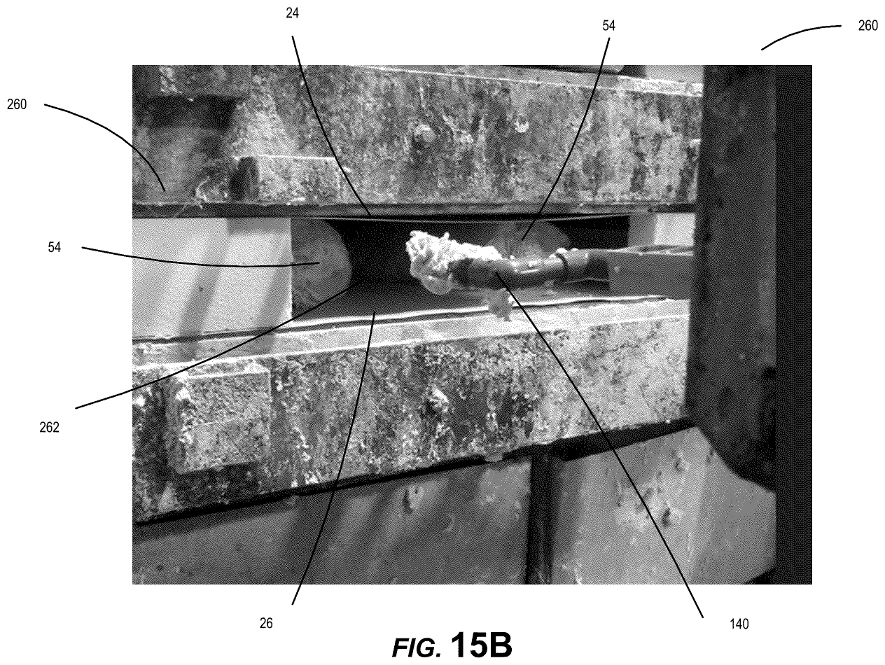

In alternate embodiments of the disclosure, as illustrated in FIGS. 15A and 15B, the equipment may be discontinuous panel manufacturing equipment 250 having static molds 260 and dynamic applicators 140. As such, in some embodiments, the uncoilers 110, 120, rollformers 112, 114, and/or panel separators 170 may be used to form the first substrate 24 and/or second substrate 26 with the edges 34, 36. The first substrates 24 and/or second substrates 26 may be inserted into one or more molds 260 that set the length, width, and height of the insulated panels 22. One or more moveable applicators 140 (e.g., at the same time or in succession) may extend into an aperture 262 in the mold(s) 260 between the first substate 24 and the second substrate 26 and deposit (e.g., spray, distribute, or the like) the unexpanded material 52 into the one or more molds as the one or more moveable applicators 140 are withdrawn from the one or more molds (alternatively the molds 260 may be moved with respect to the one or more applicators 140, or both the molds 260 and applicators 140 may move). The apertures 262 in the molds may be covered, and the expanding insulation material 52 continues to expand within the molds 260. The molds 260 may be allowed sit until the insulation material 50 expands and cures.

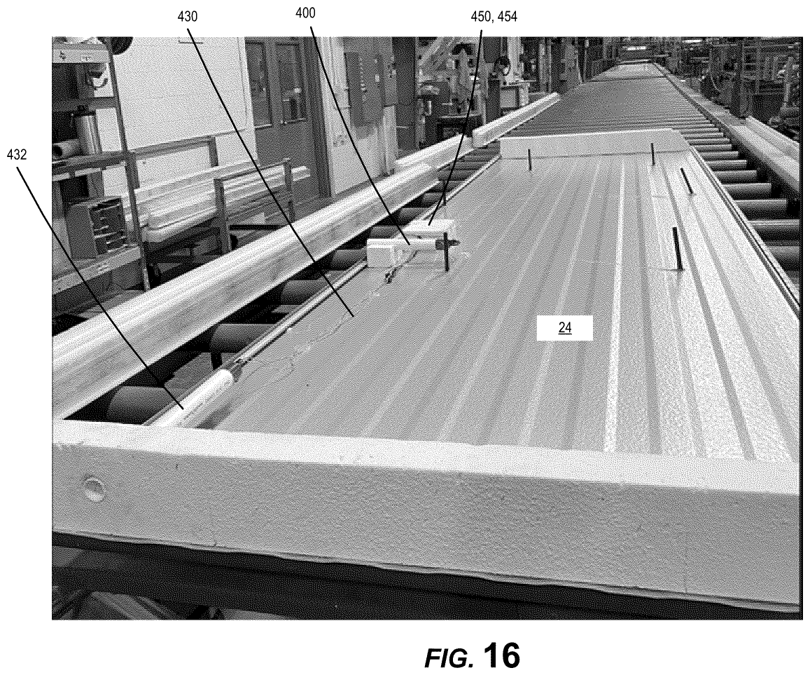

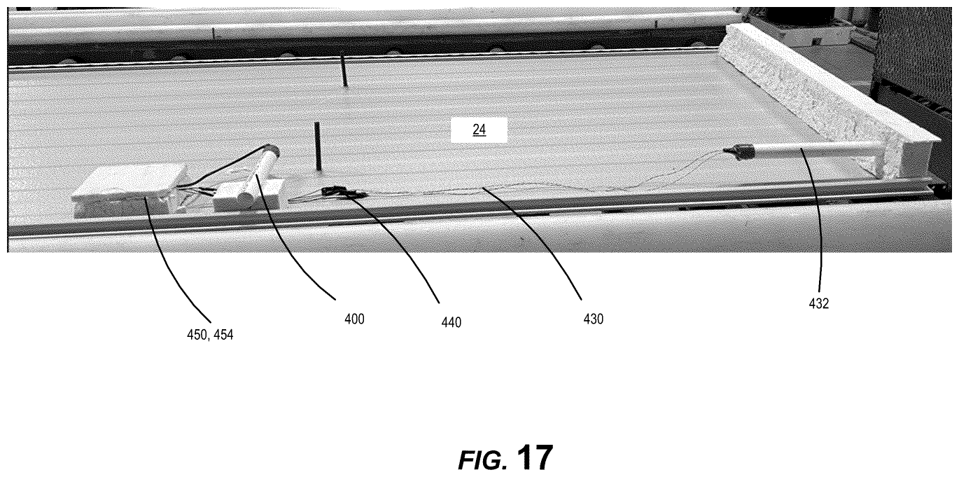

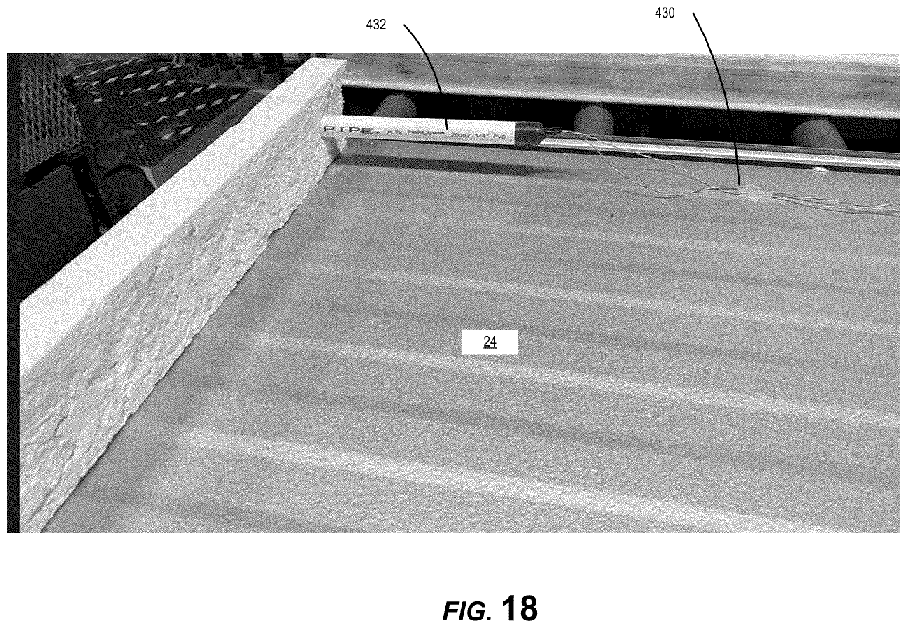

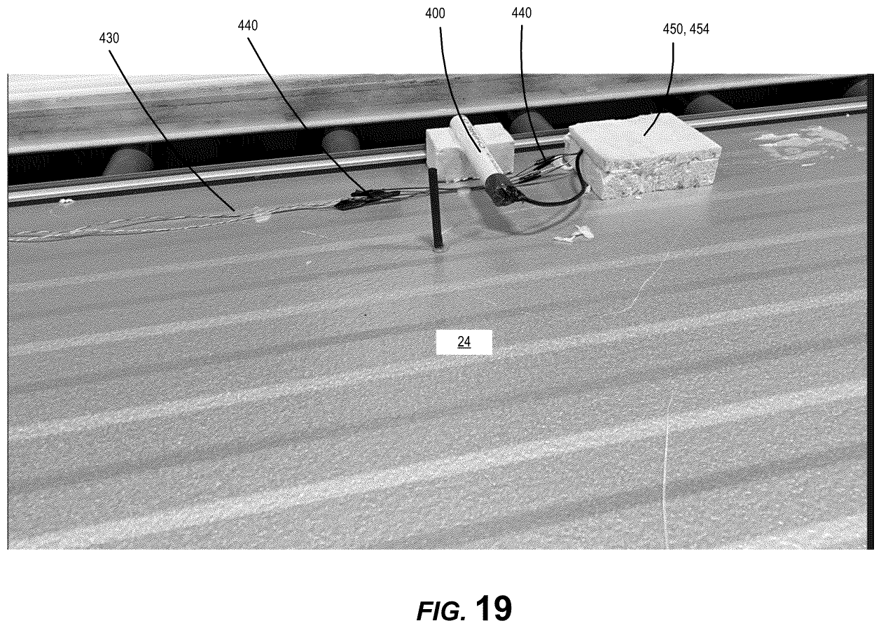

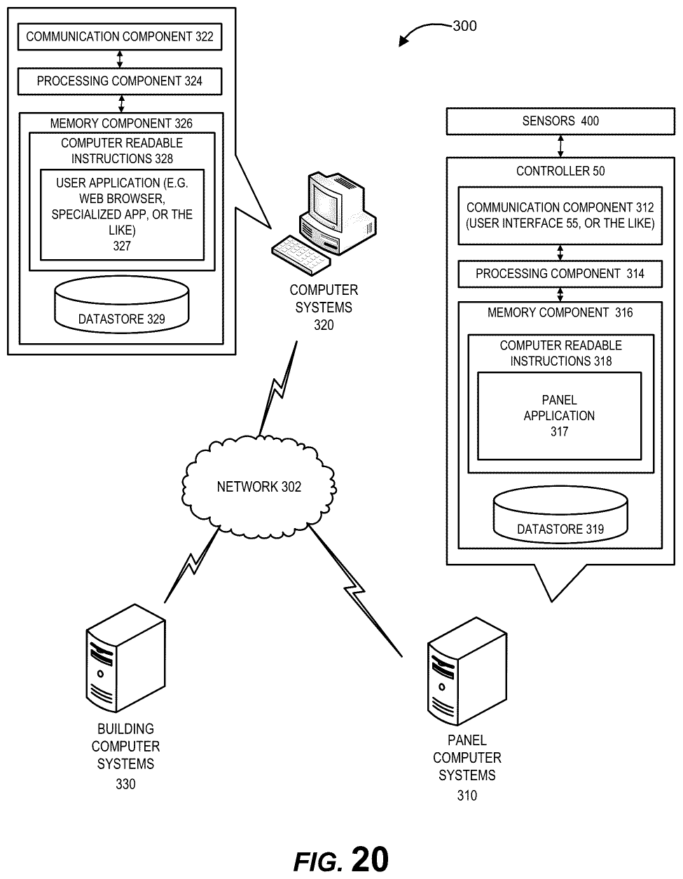

FIGS. 16 through 19 illustrate the assembly of the sensors 400, wires 430, wire housings 432, panel hubs 450 (e.g., panel hub housings 454), or the like to a substrate (e.g., a first substrate 24 or a second substrate 26). As illustrated in FIGS. 16 through 19, the sensors 400 may be operatively coupled to the substrate 24, 26 through an adhesive, blocking (e.g., made of insulation, other material, or the like), sensor housings (e.g., so as to not damage the sensors). In other embodiments, the panel hub 450 may be operatively coupled the substrate 24, 26 through a panel hub housing 454, adhesives, blocking, or the like. In the event wires 430 are being used, the wires 430 may be run to connect the panel hub 450, the sensors 400, and/or be run to a location adjacent the ends 30, 32, and/or edges 34, 36 of the insulated panel 22. In some embodiments, the wires 430 maybe located within wire housings 432 in order to aid in locating the wire 430 for connection with other panels 22 and/or for protecting the wires 430 when the insulation material 50 is applied to the insulated panels 22.

As will be described in further detail herein, an insulated panel network system 300 (e.g., insulated panel sensor network system, insulated panel lighting network system, insulated panel sensor and lighting network system, or the like) may be used to send information to and/or receive information from the sensors 400, the panel hubs 450, the lighting devices 470 or the like. As such, the sensors 400 may be used to monitor the structure 1 or the components thereof (e.g., the insulated panels 22, support members 12, or the like), the elements within the structure 1, or the internal and/or external area of the structure 1 in order to identify potential issues that have, are occurring, or may occur. In some embodiments, the systems of the building may be adjusted in order to mitigate any potential issues that have, are, or may occur (e.g., fire suppression, climate control, alarms, notifications, or the like). Moreover, as will be described in further detail herein, the sensors 400 may be used to control exterior and/or interior lighting provided by the lighting devices 470 included in the insulated panels 22. FIG. 20, which will be described in further detail herein, illustrates how the insulated panel network system 300 may be utilized to send to, and/or receive information from, the sensors 400, the panel hubs 450, and/or the lighting devices 470.

As illustrated in FIG. 20 the insulated panel network system 300 (e.g., insulated panel sensor network system, insulated panel lighting network system, insulated panel sensor and lighting network system, or the like), may be used to monitor various parameters or objects within a structure 1, such as a building, control the light devices 470 of the building's insulated panels, and/or communicate with the building computer systems 330 of the building. As illustrated in FIG. 20, one or more panel computer systems 310 (e.g., the primary hub 452, a system that communicates with the primary hub 452, or the like) are operatively coupled, via a network 302, to one or more user computer systems 320, one or more building computer systems 330, and/or one or more other systems (not illustrated). In this way, the panel computer systems 310 may communicate with users through user computer systems 320 and/or with building computer systems 330 that control portions of the building. The panel computer systems 310 may communicate with user computer systems 320 to allow the user computer systems 320 to monitor the sensors 400, information form the sensors 400, to control the lighting devices 470, and/or to allow for manual or automated control of building computer systems 330 (e.g., fire suppression, climate control, alarms, operation and/or shutdown of equipment, or the like), as will be described herein.

The network 302 may be a global area network (GAN), such as the Internet, a wide area network (WAN), a local area network (LAN), or any other type of network or combination of networks. The network 302 may provide for wireline, wireless, or a combination of wireline and wireless communication between systems, services, components, and/or devices on the network 2.

As illustrated in FIG. 20, the one or more panel computer systems 310 may comprise one or more communication components 312, one or more processing components 314, and one or more memory components 316. The one or more processing components 314 are operatively coupled to the one or more communication components 312, and the one or more memory components 316.

Each of the components within systems described herein, or across systems described herein, may be operatively coupled to one another using various BUSs and may be mounted on a common motherboard or in other manners as appropriate. As used herein, the term “processing component” generally includes circuitry used for implementing the communication and/or logic functions of a particular system. For example, a processing component may include a digital signal processor component, a microprocessor component, and various analog-to-digital converters, digital-to-analog converters, and other support circuits and/or combinations of the foregoing. Control and signal processing functions of the system are allocated between these processing components according to their respective capabilities. The one or more processing components may include functionality to operate one or more software programs based on computer-readable instructions thereof, which may be stored in the one or more memory components. As described herein, the processor component may include a number of subsystems to execute the portions of processes described herein. Each subsystem may be a self-contained component of a larger system and capable of being configured to execute specialized processes as part of the larger system.

The panel computer system 310 components, such as the one or more communication components 312, may be operatively coupled to the one or more sensors 400 and/or light devices 470 directly, or indirectly through the use of the panel hubs 450 and/or the primary hub 452.

The one or more processing components 314 use the one or more communication components 312 to communicate with the network 302 and other components on the network 302, such as, but not limited to, the components of the one or more user computer systems 320, the one or more building computer systems 330, and/or the one or more other systems (not illustrated). As such, the one or more communication components 312 generally comprise a wireless transceiver, modem, server, electrical connection, electrical circuit, or other component for communicating with other components on the network 302. The one or more communication components 312 may further include an interface that accepts one or more network interface cards, ports for connection of network components, Universal Serial Bus (USB) connectors, or the like. Moreover, the one or more communication components 312 may include a keypad, keyboard, touch-screen, touchpad, microphone, mouse, joystick, other pointer component, button, soft key, and/or other input/output component(s) for communicating with users.

As further illustrated in FIG. 20, the one or more panel computer systems 310 comprise computer-readable instructions 318 stored in the one or more memory components 316, which in some embodiments includes the computer-readable instructions 318 of the one or more panel applications 317 (e.g., used to communicate with and/or operate the sensors 400 and/or light devices 470 and/or the components thereof, or the like). In some embodiments, the one or more memory components 316 include one or more data stores 319 for storing data related to the insulated panels 22 (e.g., sensors 400, light devices 470, or the like), including, but not limited to, data created, accessed, and/or used by the panel computer systems 310.

As illustrated in FIG. 20, users may communicate with each other over the network 302 and the panel computer systems 310, the building computer systems 330, and/or other systems in order to control and/or monitor the sensors 400 and/or light devices 470, and/or communicate and/or control the building computer systems 330. Consequently, the one or more users may be employees, agents, representatives, officers, or the like of an organization operating the building. The one or more user computer systems 320 may be a desktop, laptop, tablet, mobile device (e.g., smartphone device, or other mobile device), or any other type of computer that generally comprises one or more communication components 322, one or more processing components 324, and one or more memory components 326.

The one or more processing components 324 are operatively coupled to the one or more communication components 322, and the one or more memory components 326. The one or more processing components 324 use the one or more communication components 322 to communicate with the network 302 and other components on the network 302, such as, but not limited to, the panel computer systems 310, the building computer systems 330, and/or the other systems (not illustrated). As such, the one or more communication components 322 generally comprise a wireless transceiver, modem, server, electrical connection, or other component for communicating with other components on the network 302. The one or more communication components 322 may further include an interface that accepts one or more network interface cards, ports for connection of network components, Universal Serial Bus (USB) connectors and the like. Moreover, the one or more communication components 322 may include a keypad, keyboard, touch-screen, touchpad, microphone, mouse, joystick, other pointer component, button, soft key, and/or other input/output component(s) for communicating with the users. In some embodiments, the one or more communication components 322 may comprise a user interface, such as a graphical user interface that allows a user to remotely control and/or monitor the sensors 400 and/or the light devices 470.

As illustrated in FIG. 20, the one or more user computer systems 320 may have computer-readable instructions 328 stored in the one or more memory components 326, which in some embodiments includes the computer-readable instructions 328 for user applications 327, such as dedicated applications (e.g., apps, applet, or the like), portions of dedicated applications, a web browser or other apps that allow access to applications located on other systems, or the like. In some embodiments, the one or more memory components 326 include one or more data stores 329 for storing data related to the one or more user computer systems 320, including, but not limited to, data created, accessed, and/or used by the one or more user computer systems 320. The user application 327 may use the applications of the panel computer systems 310, the one or more building computer systems 330, and/or one or more other systems (not illustrated) in order to communicate with other systems on the network 302 and take various actions described herein (e.g., operating, using, monitoring, or the like the sensors 400 and/or light devices 470).

In some embodiments, the user may use the user computer systems 320 to transmit and/or receive information or commands to and from the other systems via the network 302. Any communication between the systems and the user computer system 320 may be subject to an authentication protocol allowing the systems to maintain security by permitting only authenticated users (or processes) to access the protected data of the systems, which may include servers, databases, applications, and/or any of the components described herein. To this end, the systems may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected systems. Similarly, the user computer systems 320 may provide the systems (or other client devices) permissioned access to the protected data.

Moreover, as illustrated in FIG. 20, the one or more building computer systems 330 and/or other systems (not illustrated) have components the same as or similar to the components described with respect to the panel computer systems 310 and the one or more user computer systems 320 (e.g., one or more communication components, one or more processing components, one or more sensors, one or more memory devices with computer-readable instructions of one or more product applications, one or more datastores, or the like). Thus, the one or more building computer systems 330 communicate with the one or more panel computer systems 310, the one or more user computer systems 320, and/or one or more other systems in same or similar way as previously described with respect to the one or more panel computer systems 310, the one or more user computer systems 320, and/or the one or more other systems (not illustrated). The one or more building computer systems 330 may comprise the computer systems (e.g., remotely, in the equipment, or the like) that operate the systems, machines, robots, components, or the like in the building on which the insulated panels 22 are installed.

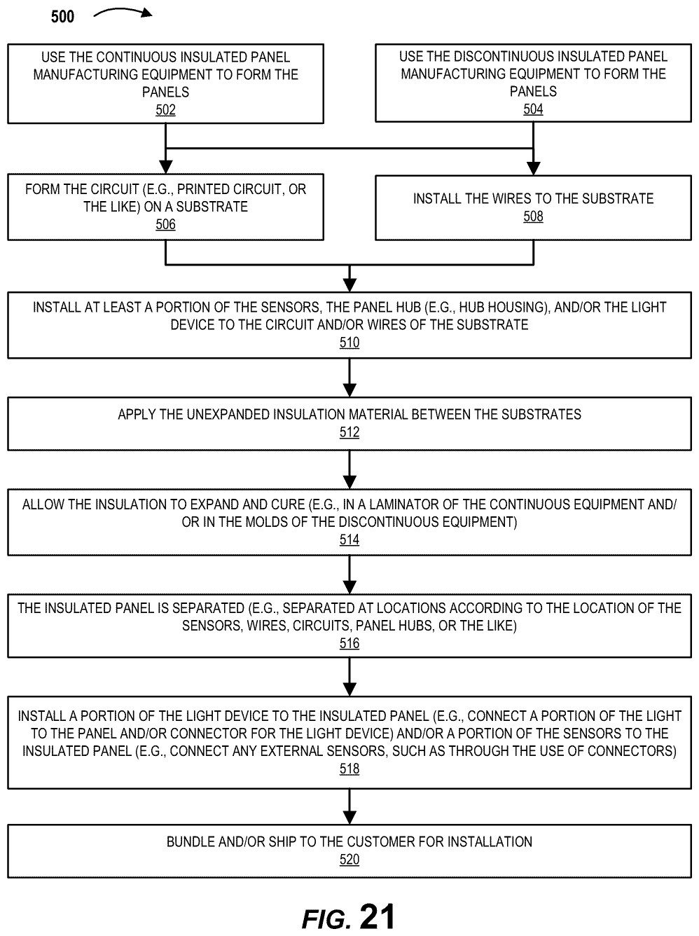

FIG. 21 illustrates a process 500 for manufacturing the insulated panels 22 described herein. As illustrated in block 502, the continuous insulated panel manufacturing equipment 100 may be used to form the insulated panels 22 described herein. Alternatively, the insulated panels 22 described herein may be formed through the use of the discontinuous panel manufacturing equipment 250, as illustrated in block 504.

Regardless of using the continuous equipment or the discontinuous equipment, as illustrated in block 506, in some embodiments the circuit 434 (e.g., the printed circuit, or the like) may be formed on one or more of the substrates 24, 26 (e.g., in-line in the continuous process, on individual panels in the discontinuous process). For example, as described herein, the circuit 434 may be printed on the substate (e.g., first substrate 24, second substrate 26) in order to create the foundation for the connections between the sensors 400, hubs 450, light devices 470, or the like.

Alternatively, regardless of using the continuous equipment or the discontinuous equipment, as illustrated in block 508, the wires 430 are installed to the one or more substrates (e.g., a first substrate 24, a second substrate, or both). As previously described herein the wires 430 may be operatively coupled to a substrate 24, 26 using adhesive, or the like, may be installed through the use of wire housings 432, both, or the like. Additionally, or alternatively, the printed circuit and/or at least some of the wires are not necessary since at least some of the sensors 400 and/or hubs 450 may utilize wireless communication and/or power transmission.

As illustrated in block 510 of FIG. 21, at least portions of the sensors 400, the panel hub 450, and/or the light devices 470 may be installed to the one or more substrates 24, 26. For example, a portion of the sensor 400 (e.g., to which another sensor portion may be installed after the panel 22 is formed, or the like), the entire sensor 400, or the like may be installed to the circuit 434, the wires 430, and/or the substrates 24, 26 (e.g., when wire communication is used). That is, the sensors 400 may be operatively coupled to the wires 430 through the use of electrical connectors 440. Additionally, or alternatively, the sensors 400 may be operatively coupled directly to the circuit 434 (e.g., the printed circuit) through a direct connection (e.g., conductive connection, such as a pinned connection, conductive material, or the like) or in some embodiments an electrical connector 440 that is operatively coupled to the circuit 434. The panel hub 450 (e.g., primary hub 452, panel hub housings 454, or the like) may be operatively coupled to one or more substrates 24, 26 and/or the sensors 400, as previously described with respect to the connection of the sensors 400 (e.g., wired connections, direct connections, or the like). Moreover, while the light devices 470 may be typically installed on the outside of the insulated panel 22, in some embodiments, at least a portion of the light devices may be operatively coupled to the substrate 24, 26 and/or the panel hub 450 in the same or similar way as described with respect to the sensors 400.

Block 512 of FIG. 21 further illustrates that the unexpanded insulation material 52 is applied between the substrates 24, 26, through the continuous insulated panel manufacturing equipment 100 or the discontinuous panel manufacturing equipment 250, as previously described herein.

FIG. 21 further illustrates in block 514 that the unexpanded insulation material 52 is allowed to expand and/or cure (e.g., in a laminator 160 of the continuous equipment, in the molds 260 of the discontinuous panel manufacturing equipment 250, or the like), resulting in the insulation material 50.

Block 516 of FIG. 21 illustrates that the insulated panel 22 is separated. Due to the location of the sensors 400, the panel hubs 450, the light devices 470, and/or the electrical connectors 440 within the insulated panel 22, the insulated panel 22 may be separated in specific locations. When using the continuous equipment, the insulated panel 22 may be separated in specific locations at the panel ends 30, 32 based on the location of the insulated panel 22 components. When using the discontinuous equipment, the insulated panels 22 are separated from the molds 260 with the ends 30, 32 already defined by the molds.

FIG. 21 further illustrates in block 518, when the light devices 470 are used, at least a portion of the light devices 470 may be installed to the insulated panel 22. For example, portions of the light devices 470 may be installed to an edge 34, 36 of the insulated panel 22 and/or to light connector within the insulated panel 22. Alternatively, or additionally, portions of the sensors 400 may be installed to the insulated panel 22. For example, external sensors may be connected to the insulated panel 22 through the use of electrical connectors 440.

While it has been described herein that the wires 430, sensors 400, and/or hubs 450 may be at least partially operatively coupled to a substrate 24, 26 before the insulation material 50 is applied, it should be understood that the wires 430, sensors 400, and/or hubs 450 may be operatively coupled to one or more insulated panels 22 after formation of the panels 22. For example, at least a portion of a substrate 24, 26, and/or insulation material 50 may be removed after the insulated panel 22 is formed, and at least a portion of the wires 430, sensors 400, and/or hubs 450 may be operatively coupled to the one or more insulation panels 22. After installation of the wires 430, sensors 400, and/or hubs 450 at least a portion of the insulation material 50 and/or substrate 24, 26 may be reassembled to the insulated panel 22 (e.g., through connectors, such as fasteners, welds, adhesive, tape, caulk, mastic, or the like).

Block 520 of FIG. 21 illustrates at the insulated panels 22 may be bundled and shipped to the customer for installation on a structure 1.

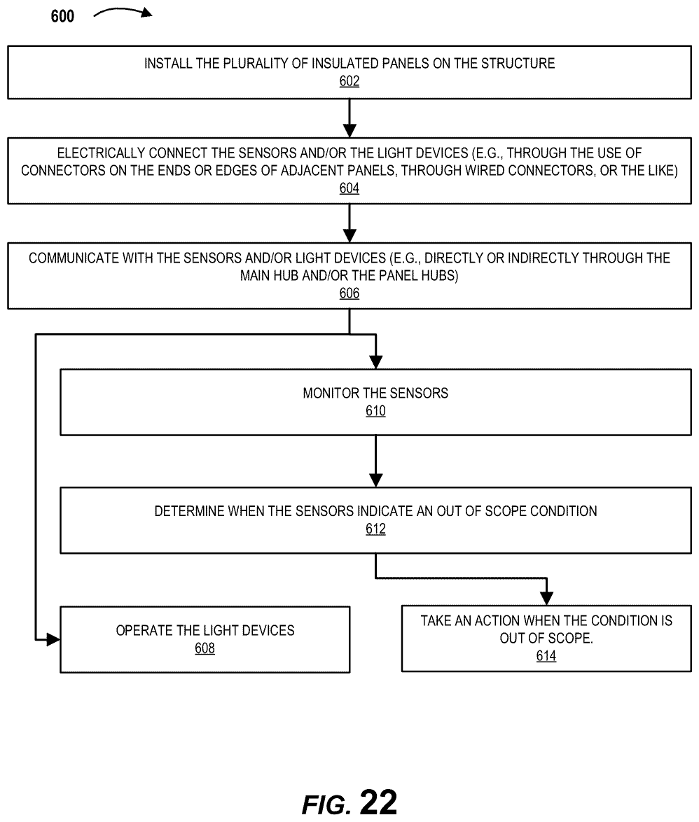

FIG. 22 illustrates a process 600 for installing the insulated panels 22 and/or operating the insulated panel network system 300. Block 602 of FIG. 22 illustrates that the insulated panels 22 are installed on the structure 1. For example, as previously described with respect to FIG. 1, the insulated panels 22 may be installed to support members 12 with first ends 30 of panels located adjacent to second ends 32 of adjacent panels in a horizontal configuration. Moreover, first edges 34 of panels are installed to second edges 36 of adjacent panels in a vertical configuration.

Block 604 of FIG. 22 further illustrates that the sensors 400 and/or the light devices 470 of the insulated panels 22 are electrically connected. For example, the connections may be directly through the ends 30, 32 and/or edges 34, 36 of the insulated panels 22. Additionally, or alternatively, the connections may be through the use of wired connectors 440 and/or wireless connections, or the like, as previously discussed herein.

FIG. 22 further illustrates in block 606 that after installation of the insulated panels 22 and/or the connection of the sensors 400 and/or light devices 470, a user may utilize the insulated panel network system 300 to communicate with the sensors 400 and/or light devices 470. For example, as previously described with respect to the insulated panel network system 300, a user computer system 320 may be used to wireless communicate with multiple sensors 400 and/or light devices 470 of the installed insulated panels 22 directly or through the use of primary hub. As such, as previously discussed herein, the insulated panels 22 may communicate with each other and/or a user through the panel hubs 450 and/or a primary hub 452.

As illustrated by block 608 of FIG. 22, the user may manually, and/or a computer system may automatically, operate the light devices 470 of the insulated panels 22. For example, as described herein, depending on the location of the light devices 470, the exterior light devices 470 on the external surface of the panels 22 may be activated at night, while interior light devices 470 on the internal surfaces of the panels 22 may be activated during working hours within the structure 1 and/or at specific locations within the structure when different locations of the structure are being used.

Additionally, or alternatively, the user may manually, and/or a computer system may automatically, operate the sensor(s) 400 of the insulated panels 22. For example, the sensor(s) 400 may be activated to collect position, location, environmental (e.g., temperature, humidity, gas, wind, or the like), pressure, or any other parameters described herein with respect to the sensors 400.

Block 610 of FIG. 22 further illustrates that the sensors 400 may be monitored (e.g., continuously, at intervals, or the like) using the insulated panel network system 300 in order to monitor conditions around or in the structure, as previously discussed herein. For example, as previously discussed, the sensors 400 may be pressure sensors, position sensors, location sensors, temperature sensors, humidity sensors, gas sensors, wind sensors, or the like. As such, the sensors 400 may be monitored in order to identify when and/or where issues with the structure and/or around the structure may be occurring.

FIG. 22 further illustrates in block 612 that the insulated panel network system 300 may be used to determine when the one or more sensors 400 provide a reading that is out-of-scope (e.g., one that is outside of predetermined operating conditions, such as thresholds, or the like). For example, operating conditions may be set and stored for one or more of the sensors 400 (e.g., threshold settings, ranges, or the like). The insulated panel network system 300 automatically (or a user manually using the system) may determine when the sensors 400 do not meet one or more of the operating conditions (e.g., are outside of the threshold, are inside of a threshold, are above or below a threshold, or the like).

Block 614 of FIG. 22 illustrates that when a sensor 400 identifies an operating condition that is out-of-scope, the insulated panel network system 300 may take an action. For example, the action may be notifying a user (e.g., notifying a user to take an action), changing the climate control of the building, setting off an alarm (e.g., fire/smoke alarm, unauthorized access alarm, or the like), turning light devices on or off, adjusting the predetermined operating conditions, and/or taking other actions, such as the actions previously described herein.

It should be understood that artificial intelligence and/or machine learning (ML) may be utilized to analyze and/or use the data described herein. For example, a generative AI subsystem and/or a machine learning (ML) subsystem may include a data ingestion engine, a data pre-processing engine, and/or a model training engine. It should be understood that the generative AI subsystem and/or ML subsystem is merely an example, and other embodiments may include more, fewer, or different components depending on the specific requirements and implementations of the system. As such, it should be further understood, that the AI and/or ML subsystems may use the same or similar engines and/or different engines, which may include the engines described herein or may include other engines not specifically described herein. For instance, additional engines for data validation, feature selection, distributed computing, model tuning, inference, or the like may be integrated into the subsystem, or certain components described herein may be consolidated or omitted based on system performance objectives. Therefore, the generative AI subsystem and/or ML subsystem should not be considered limiting and may be adapted to various configurations within the scope of the disclosure.

The data ingestion engine may identify various internal and/or external data sources to generate, test, and/or integrate new features for training the generative AI model and/or ML model. These internal and/or external data sources (e.g., text corpora, web-based text data, document repositories, or decentralized text storage system) may be initial locations where the data originates or where physical information is first digitized. In addition to conventional data sources, the data ingestion engine may support decentralized storage systems, such as blockchain-based data sources, and privacy-preserving methods such as differential privacy. The data ingestion engine may identify the location of the data and describe connection characteristics for access and retrieval of data. In some embodiments, data is transported from each data source using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the data sources may include Enterprise Resource Planning (ERP) databases that host data related to day-to-day business activities such as accounting, procurement, project management, exposure management, supply chain operations, and/or the like, mainframes that are often the entity's central data processing center, edge devices that may be any piece of hardware, such as sensors, actuators, gadgets, appliances, or machines, that are programmed for certain applications and may transmit data over the internet or other networks, and/or the like.

Depending on the nature of the data, the data ingestion engine may move the data to a destination for storage or further analysis. Typically, the data may be in varying formats as the data comes from different sources, including RDBMS, other types of databases, S3 buckets, CSVs, or from streams. For a large language model (“LLM”), text data may originate from sources such as web scrapes, social media, large public text datasets, or the like. Since the data may come from different places, the data needs to be cleansed and transformed so that the data may be analyzed together with data from other sources. The data may be ingested in real-time, using stream processing, in batches using a batch data warehouse, or in a combination of both. Stream processing may be used to process continuous data streams (e.g., data from edge devices) by computing on data directly as it is received, and filtering the incoming data to retain specific portions that are deemed useful by aggregating, analyzing, transforming, and/or ingesting the data. On the other hand, the batch data warehouse may collect and transfer data in batches according to scheduled intervals, triggered events, and/or any other logical ordering.

The generative AI subsystem and/or ML subsystem may utilize one or more machine learning techniques to generate new content. In machine learning, the quality of data and the useful information that may be derived therefrom directly affects the ability of the machine learning model to learn. The data pre-processing engine may implement advanced integration and processing steps needed to prepare the data for machine learning execution, including tokenization, text normalization, and/or removal of irrelevant elements like HTML tags in web-based data, especially for LLM training. This may include modules to perform any upfront data transformation to consolidate the data into alternate forms by changing the value, structure, and/or format of the data by using generalization, normalization, attribute selection, aggregation, and text-specific transformations such as stemming and lemmatization to data clean by filling missing values, smoothing the noisy data, resolving the inconsistency, removing outliers, and/or any other encoding steps as needed. In some embodiments, the data pre-processing engine may perform real-time pre-processing at the edge via edge computing devices, allowing for the transformation and reduction of data prior to transmission to centralized locations, thereby reducing latency and conserving network bandwidth.

In addition to improving the quality of the data, the data pre-processing engine may transform categorical data into numerical formats that may be suitable for machine learning algorithms. In this regard, the data pre-processing engine may use techniques such as one-hot encoding or label encoding depending on the nature of the categorical variables and the intended use of the data.

In some embodiments, the data pre-processing engine may also include dimensionality reduction techniques, where the number of input features is reduced while retaining the most relevant information. In this regard, the data pre-processing engine may include methods such as Principal Component Analysis (PCA) or apply feature selection algorithms to remove redundant or irrelevant features, thereby reducing the computational complexity of the model training phase. Feature selection may be particularly beneficial in datasets with a high number of features, ensuring that the generative AI models do not overfit to noise or irrelevant details. The pre-processed data output from the data pre-processing engine may then be fed into the model training engine.

The model training engine may be responsible for training the generative AI models using the pre-processed data from the data pre-processing engine. The model training engine may implement various machine learning algorithms, including but not limited to Generative Adversarial Networks (GANs), Variational Autoencoders (VAEs), transformers, diffusion models, and/or other specialized architectures depending on the specific requirements of the system. These models may be used in a broad range of applications, such as LLMs for text generation, image generation models, video synthesis models, audio generation models, and/or the like. The model training engine may optimize these models by continuously adjusting their internal parameters based on the patterns and relationships identified within the data.

In some embodiments, the model training engine may include a training data handler, which manages the partitioning of the pre-processed data into training, validation, and testing datasets. The training data may be used to update the model's parameters, while the validation and testing datasets may be reserved to evaluate the model's performance during and after training. The model training engine may support various data-handling strategies, such as cross-validation or random shuffling, to ensure that the model generalizes well and is not overfitting to the training data.

In embodiments involving large language models, the model training engine may utilize transformer-based architectures, such as the Transformer, BERT, GPT, or the like. Transformer models rely on mechanisms like self-attention to capture dependencies between words in a sequence, regardless of their distance from one another. The self-attention mechanism allows the model to weigh the importance of different words in a sentence and establish complex relationships important for understanding context. During training, the model may process vast amounts of text data and learn to predict the next word or token in a sequence based on the input context. This training process allows LLMs to generate coherent text, complete sentences, translate languages, or answer questions based on learned patterns from the data.

The transformer-based LLMs may be trained using autoregressive (e.g., GPT) or masked-language modeling techniques (e.g., BERT). In autoregressive models, the training process may include predicting the next word in a sequence by progressively revealing more context to the model. The model iteratively improves its predictions based on its performance during prior iterations. Masked-language modeling involves masking certain words in a sentence and training the model to correctly predict the masked words based on surrounding context. Both approaches enable LLMs to capture intricate patterns in human language, improving their ability to handle tasks such as summarization, translation, and text generation. Loss functions like cross-entropy loss may be used to optimize the model's performance by comparing predicted tokens with the actual tokens in the dataset to guide the model to minimize prediction errors during training, as described in further detail herein.

In embodiments involving image generation models, the model training engine may utilize transformer-based architectures, such as Vision Transformers (ViTs) or generative adversarial networks (GANs). Vision Transformers rely on self-attention mechanisms to process images as sequences of patches rather than whole images, allowing the model to capture spatial dependencies and patterns across the image. During training, the model may be exposed to large datasets containing diverse image types to learn features like textures, edges, and shapes. The model may then generate or reconstruct images by interpreting these patterns and applying learned spatial relationships. GAN-based models may also be used, where a generator network creates images, and a determinator network evaluates their realism, enabling the model to improve through adversarial training.

Image generation models may employ various training techniques, such as pixel-wise reconstruction or adversarial training, depending on the architecture. Pixel-wise reconstruction methods involve learning to reconstruct an image from its corrupted or downscaled version, optimizing the model to minimize the difference between the predicted and actual pixels (e.g., using mean squared error as the loss function). Adversarial training, often used with GANs, involves iteratively improving the generator network to produce images that are increasingly indistinguishable from real images, based on feedback from the determinator network. These approaches allow the model to capture complex visual features, enabling applications such as image synthesis, enhancement, and style transfer.

For video generation models, the model training engine may employ transformer-based architectures like Video Transformers or GAN-based models specifically designed for handling temporal sequences. Video Transformers use self-attention mechanisms to model dependencies not only between pixels within a single frame but also across frames, allowing them to understand temporal relationships and motion patterns in videos. The model may be trained on large video datasets, enabling it to learn and reproduce dynamic changes and interactions between objects over time. GAN-based video models may incorporate spatiotemporal networks to evaluate the realism of generated video sequences, optimizing the model to produce continuous and coherent frames.

Video generation models may utilize spatial-temporal modeling techniques or adversarial training for generating realistic motion and video sequences. Spatial-temporal modeling involves learning the spatial features within each frame while simultaneously capturing the temporal dependencies between frames, optimizing the model's ability to predict future frames or complete missing sequences. Loss functions like mean squared error or perceptual loss may be applied to reduce discrepancies between predicted and actual frames. Adversarial training, on the other hand, may involve a generator creating video sequences and a determinator evaluating their realism, encouraging the generator to improve by minimizing the discrepancy identified by the determinator. These techniques may enable video generation models to create coherent and realistic sequences, useful in applications such as video synthesis and animation.

In audio generation models, the model training engine may utilize architectures such as Audio Transformers or recurrent neural networks (RNNs) like WaveNet, designed to handle sequential and waveform data. Audio Transformers leverage attention mechanisms to capture relationships between segments of audio, allowing them to model temporal dependencies and predict the next audio sample based on previous context. During training, the model may process large audio datasets containing diverse sound patterns to learn representations of different audio features, such as frequency, amplitude, and harmonics. This training enables the model to generate coherent audio sequences, including speech, music, or ambient sounds, by synthesizing these learned patterns.

Audio generation models may be trained using sequence modeling techniques or autoregressive methods, depending on the architecture. Sequence modeling techniques involve processing and predicting sequences of audio samples, optimizing the model to capture and reproduce temporal dependencies in sound. Autoregressive methods, such as those employed in WaveNet, focus on predicting each audio sample based on prior samples, progressively refining the generated audio sequence over multiple iterations. Loss functions like mean absolute error or cross-entropy loss may be used to minimize the error between predicted and actual audio samples, guiding the model to improve its accuracy. These approaches allow audio generation models to create continuous and realistic audio outputs, applicable in areas such as speech synthesis, music generation, and sound effect creation.

The reconstruction loss ensures that the difference between the original input and the reconstructed output is minimized, guiding the decoder to generate outputs that closely resemble the input data. The second component, KL divergence loss, regularizes the latent space by ensuring that the distribution of latent variables conforms to a predefined probabilistic distribution, often a Gaussian distribution. This constraint encourages the model to learn a well-organized and smooth latent space, allowing for meaningful sampling from this space during inference. By combining these loss functions, the VAE can learn a latent space that not only captures the underlying patterns in the data but also allows for the generation of novel outputs by sampling new points from this space. During the inference phase, the trained model can sample random points from the latent space to generate new, previously unseen data instances.

In training generative AI models, the model training engine, which includes an optimization module, may implement various optimization techniques to improve model performance and efficiency. The optimization module is responsible for adjusting the model's internal parameters continuously, using feedback from relevant loss functions tailored to the application (e.g., text, image, audio, or video generation). Techniques such as gradient clipping, learning rate scheduling, and mixed-precision training are applied by the optimization module to stabilize and fine-tune the training process. Gradient clipping may be used to stabilize the training process, especially in transformer-based models, by capping the magnitude of gradients to prevent them from becoming excessively large. Learning rate scheduling may involve gradually increasing the learning rate during initial training phases (warm-up) and then decaying it as training progresses to fine-tune the model's parameters more effectively. Mixed-precision training, which leverages lower-precision (e.g., float16) arithmetic while retaining higher precision (e.g., float32) for specific calculations, may be used to accelerate training and reduce memory consumption, enabling the model to scale efficiently even when trained on large datasets.

In some embodiments, the model training engine may implement early stopping mechanisms to prevent overfitting. Early stopping monitors the generative AI model's performance on the validation dataset, halting the training process if the performance does not improve after a specified number of iterations. This ensures that the generative AI model does not continue training on noise or irrelevant patterns, which could degrade its performance on unseen data. The model training engine may also support distributed training across multiple computing nodes, allowing the system to scale its computational resources as needed. Distributed training may involve splitting the generative AI model and data across multiple machines or GPUs, where each node processes a portion of the data and updates the model in parallel. This is particularly useful for large datasets or models that require significant computational power, such as deep generative models. The model training engine may synchronize the updates across the nodes using techniques like synchronous or asynchronous gradient descent.

Once the generative AI model is trained, the model training engine may save the final trained generative AI model in a persistent storage location for future use. In specific embodiments, metadata such as the number of epochs, the final loss values, and values of learned parameters may be logged for model versioning and/or retraining at a later stage. In some embodiments, the model training engine may also implement transfer learning, where a pre-trained model is fine-tuned on a smaller, domain-specific dataset. This may reduce the amount of time and data required to train a new model, especially in cases where the available data is limited or highly specialized. The model training engine may adjust the parameters of the pre-trained model to better align with the new dataset, while preserving the learned features from the original training.

In embodiments involving LLMs, new output is generated by sampling from the model's probability distribution of tokens, conditioned on the context provided as input. Transformer-based architectures, such as GPT, use an auto-regressive approach where the model predicts the next token in a sequence one step at a time, using previously generated tokens as input for subsequent predictions. The process starts with a prompt or an initial sequence of words, and the model iteratively generates new tokens, forming coherent sentences or paragraphs based on the learned context and language patterns. For masked-language modeling (e.g., BERT), new output may be generated by filling in masked parts of the input sequence, allowing the model to complete sentences or generate variations of the provided text. The generated output can be controlled by adjusting parameters such as temperature, which influences the randomness of the token sampling, enabling the generation of diverse or deterministic responses.

In image generation models, such as those using ViTs or GANs, new output is generated by sampling from the learned distribution in the model's latent space. For GANs, the generator network creates an image by transforming random noise vectors into structured image outputs through a series of layers that learn visual features like shapes, textures, and colors. The generated image is then refined through adversarial feedback from the determinator network, which assesses the realism of the generated output. For transformer-based image models, the process may involve reconstructing images by assembling patches based on the learned dependencies between them. Input conditions, such as prompts describing desired features or specific noise vectors, guide the generation process, allowing for the creation of customized images or variations of existing visual styles. These models may also generate images based on style transfer techniques or predefined templates, synthesizing images that align with the characteristics present in the training data.

Video generation models utilize spatiotemporal dependencies to synthesize new video sequences based on the patterns learned during training. In transformer-based architectures, the model may generate video frames sequentially, predicting the next frame based on the input frames and the temporal context established by prior frames. GAN-based models, specifically designed for video synthesis, may sample noise vectors or use a sequence of frames as input, transforming these into continuous and temporally coherent video outputs through the generator network. The determinator evaluates the temporal consistency and realism of the output, ensuring the generated video mimics the motion dynamics and object interactions present in real-world video data. Such models may also use attention mechanisms to focus on critical elements within each frame and their evolution across time, facilitating realistic scene transitions and motion patterns. The generation process may include user-defined input such as initial frames, motion descriptions, or specific video attributes, providing control over the output.

Audio generation models, including Audio Transformers or autoregressive architectures like WaveNet, generate new audio sequences by predicting audio samples based on learned dependencies in sequential sound data. For autoregressive models, the generation process involves producing each audio sample one at a time, conditioned on previously generated samples, allowing the model to build complex audio patterns such as speech, music, or ambient sounds. The model starts with an initial segment or a random seed and uses its learned parameters to predict and synthesize subsequent samples, constructing a continuous audio waveform. Audio Transformers, on the other hand, may use attention mechanisms to identify important temporal segments within the input audio and synthesize new output based on these learned patterns. The user can control the type of audio generated by providing parameters such as pitch, tempo, or initial sound clips, enabling the model to generate outputs tailored to specific use cases like speech synthesis, music composition, or environmental sound generation.

In some embodiments, generative AI models may also integrate multiple modalities, enabling cross-modal generation where output in one modality influences or conditions the generation in another. For example, a video generation model may use text descriptions as input, synthesizing video content that aligns with the specified narrative or visual scene described. Similarly, image generation models may generate visual representations based on audio inputs, such as generating animations synchronized to musical rhythms or speech patterns. These cross-modal systems typically involve conditional GANs or multi-modal transformers, where the model processes input from one domain (e.g., text or audio) and learns to generate output in another domain (e.g., video or image) by aligning the patterns and dependencies between the different modalities. These models may allow users to generate complex, multimodal content based on combinations of inputs, such as using textual prompts to control the visual and auditory elements of a video.

It will be understood that the embodiment of the generative AI subsystem illustrated is exemplary and that other embodiments may vary. The generative AI subsystem, as well as its constituent elements, may vary, and modifications or alternative configurations may be implemented without departing from the broader scope of the disclosure. For instance, different machine learning algorithms, data sources, optimization techniques, or training methodologies may be employed depending on system requirements, application domain, and available computational resources. Furthermore, features and functionalities described in one embodiment may be combined with those of another embodiment as needed, and vice versa.

In machine learning, the quality of data and the useful information that may be derived therefrom, directly affects the ability of the machine learning model to learn. The data pre-processing engine may implement advanced integration and processing steps needed to prepare the data for machine learning execution. This may include modules to perform any upfront data transformations to consolidate the data into alternate forms by changing the value, structure, and/or format of the data by using generalization, normalization, attribute selection, and aggregation, to data clean by filling missing values, smoothing noisy data, resolving inconsistent data, removing outliers, and/or any other encoding steps as needed.

In addition to improving the quality of the data, the data pre-processing engine may implement feature extraction and/or selection techniques to generate training data. Feature extraction and/or selection is a process of transforming and/or reducing the data into new features that may better represent underlying patterns in the data. Additionally, or alternatively, feature extraction and/or selection may be a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data may require further enrichment. For example, in supervised learning, the training data may be enriched using one or more meaningful and informative labels to provide context such that a machine learning model may learn from the provided context. For example, labels may indicate whether a photo contains a bird or a car, which words were uttered in an audio recording, or if an x-ray contains a tumor. Data labeling is required for a variety of use cases including computer vision, natural language processing, and speech recognition. In contrast, unsupervised learning may use unlabeled data to find patterns in the data, such as inferences or clustering of data points.

The ML model tuning engine may be used to train a machine learning model using the training data to make predictions or decisions without explicitly being programmed to do so. The machine learning model represents what was learned by the selected machine learning algorithm and represents the rules, numbers, and any other algorithm-specific data structures required for classification. Selecting the right machine learning algorithm may depend on a number of different factors, such as the problem statement and the kind of output needed, the type and the size of the data, the available computational time, the number of features and observations in the data, and/or the like. Machine learning algorithms may refer to programs (e.g., math and logic) that may be configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, or the like), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, or the like), an instance-based method (e.g., k-nearest neighbor, learning vector quantization, self-organizing map, or the like), a regularization method (e.g., ridge regression, least absolute shrinkage and selection operator, elastic net, or the like), a decision tree learning method (e.g., classification and regression tree, iterative dichotomiser 3, C4.5, chi-squared automatic interaction detection, decision stump, random forest, multivariate adaptive regression splines, gradient boosting machines, or the like), a Bayesian method (e.g., naïve Bayes, averaged one-dependence estimators, Bayesian belief network, or the like), a kernel method (e.g., a support vector machine, a radial basis function, or the like), a clustering method (e.g., k-means clustering, expectation maximization, or the like), an associated rule learning algorithm (e.g., an Apriori algorithm, an Eclat algorithm, or the like), an artificial neural network model (e.g., a Perceptron method, a back-propagation method, a Hopfield network method, a self-organizing map method, a learning vector quantization method, or the like), a deep learning algorithm (e.g., a restricted Boltzmann machine, a deep belief network method, a convolution network method, a stacked auto-encoder method, or the like), a dimensionality reduction method (e.g., principal component analysis, partial least squares regression, Sammon mapping, multidimensional scaling, projection pursuit, or the like), an ensemble method (e.g., boosting, bootstrapped aggregation, AdaBoost, stacked generalization, gradient boosting machine method, random forest method, or the like), and/or the like.

To tune the machine learning model, the ML model tuning engine may repeatedly execute cycles of experimentation including initialization, testing, and/or calibration to optimize the performance of the machine learning algorithm and refine the results in preparation for deployment of those results for consumption or decision making. To this end, the ML model tuning engine may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data. A fully trained machine learning model is one whose hyperparameters are tuned and whose model accuracy is maximized.

The trained machine learning model, similar to any other software application output, may be persisted to storage, file, memory, or application, or looped back into the processing component to be reprocessed. More often, the trained machine learning model is deployed into an existing production environment to make practical business decisions based on live data. To this end, the machine learning subsystem uses the inference engine to make such decisions. The type of decision-making may depend upon the type of machine learning algorithm used. For example, machine learning models trained using supervised learning algorithms may be used to structure computations in terms of categorized outputs (e.g., C₁, C₂, . . . ,Cₙ) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C₁, C₂, . . . ,Cₙ) live data based on how similar they are to one another to solve exploratory challenges where little may be known about the data, provide a description or label (e.g., C₁, C₂, . . . ,Cₙ) to live data, such as in classification, and/or the like. These categorized outputs, groups (clusters), or labels may then be presented to the user input system. In still other cases, machine learning models that perform regression techniques may use live data to predict or forecast continuous outcomes.

It will be understood that the embodiment of the machine learning subsystem is exemplary and that other embodiments may vary. As another example, in some embodiments, the machine learning subsystem may include more, fewer, or different components.

In some embodiments, the integration of generative artificial intelligence and/or machine learning technologies allow improved functionality and utility of the disclosed systems and methods. For example, AI and/or ML may be implemented to analyze data collected by the sensors 400 embedded within the insulated panels 22 to optimize the operation of the structure 1. To do so, the AI/ML model may identify patterns in climate control needs to predict adjustments to heating, cooling, ventilation systems, or the like, which could lead to improved energy efficiency and reduced operational costs.

Additionally, or alternatively, the generative AI and/or ML may be used to monitor safety conditions within the structure 1. For example, by analyzing data from the sensors 400, the system could identify potential safety hazards, such as structural weaknesses, fire risks, the presence of harmful chemicals or gases, or the like.

Additionally, or alternatively, generative AI and/or ML may provide for the customization of insulated panels 22 based on specific use cases or customer needs. The model may analyze historical data and recommend configurations of sensors 400, panel hubs 450, and light devices 470 for particular applications.

Additionally, or alternatively, generative AI and/or ML could provide for predictive maintenance schedules and/or tasks by analyzing sensor data to detect anomalies in the operation of the structure 1.

Additionally, or alternatively, the generative AI and/or ML with the disclosed insulated panels 22 and associated systems could also improve decision-making for energy conservation. For example, sensor data may be fed to models that dynamically adjust lighting, temperature, or other environmental controls in response to occupancy patterns.

Embodiments of the present disclosure provide improvements through the use of sensors 400, panels hubs 450, light devices 470, the methods of manufacturing insulated panels 22 having the foregoing, and/or the systems and methods utilizing any of the foregoing. For example, the insulated panels 22 described herein may reduce costs because the sensors 400, panel hubs 450, and/or light devices 470 are pre-installed in the insulated panels 22 (e.g., before the insulated panels 22 are installed on a building), and thus, separate sensors and/or lighting do not need to be installed after assembly of the insulated panels 22. That is, including the sensors 400, panel hubs 450, and/or light devices 470 directly within the insulated panels 22 reduces the costs associated with separately purchasing, installing, and/or operating these components independent from the insulated panels 22. Moreover, by integrating the sensors 400, panel hubs 450, and/or light devices 470 within the insulated panels 22 these components can be hidden or at least partially hidden within the insulated panels 22, which provides an improved appearance of the insulated panel system. Additionally, the sensors 400 allow for the monitoring of structure 1, the operation of the structure 1, and/or the operation of the elements within the structure 1 in order to identify any potential issues that might be occurring, and thus, allowing for the mitigation (e.g., prevention, restriction, stopping, limiting, or the like) of the potential issues that might be occurring. Moreover, the sensors 400 may further allow for efficiently operating the structure 1 because the sensors 400 may be utilized to identity locations within the structure that may need improved climate control. The sensors 400 may also allow for improved safety within the structure by providing advanced feedback of potential safety hazards (e.g., structural, fire, chemical, operational, improper equipment operation, or the like). Furthermore, the sensors 400 may also be used for improved energy conservation by utilizing the sensor data to improve operation of the elements within the structure based on internal and/or external events. Furthermore, AI and/or ML may be utilized in order to analyze the data and/or to make the improvements described above.

The sensors 400, panel hubs 450, and/or light devices 470 may be customizable and/or interchangeable for different types of structures, for different purposes, and/or for different regions (e.g., with different climates, or the like) with minor changes to the manufacturing process. That is, the panels and the manufacturing processes are designed such that different sensors 400, panel hubs 450, and/or light devices 470 may be selected and/or used based on the needs of the customer without having to redesign each insulated panel 22. For example, the wires 430, circuit 434, connectors 440, or the like may allow for the use or removal of the sensors 400 and/or light devices 470, and/or the placement thereof, at different locations for each customer.

In addition to providing the benefits of having sensors 400, panel hubs 450, and/or light devices 470, as discussed herein, the insulated panels 22, like traditional panels, still meet the specifications that traditional panels meets, such as but not limited to water absorption of less than or equal to 30% (under ASTM C272/AC04); density of greater than or equal to 2.0 lb/ft³ (under ASTM D1622); mass loss of less than or equal to 20% (under ASTM C421); core compression (x) that is greater than or equal to 20 lb/in², core compression (y) that is approximately equal to the core compression (x), and/or core compression (z) that is less than or equal to twice the core compression (x) (under ASTM D1621); tensile adhesion (face) and tensile adhesion (foam) that is greater than or equal to 20 lb/in², and tensile adhesion (liner) that is greater than or equal to 16 lb/in² (under ASTM D1623); thermal conductivity at 75 degrees F. that is less than or equal to 0.140 BTU*in/hr*ft²* degree|R of 7.1 per inch, and thermal conductivity at 35 degrees F. that is less than or equal to 0.112 BTU*in/hr*ft²* degree|R of 7.1 per inch (under ASTM C518); and/or other specification not specifically outlined herein at the time of filing this application or as updated from time to time.

While the present disclosure has been described with particular reference to the drawings, it should be understood that various modifications could be made without departing from the spirit and scope of the present disclosure. For instance, while the panels 22 are shown and described as being connected to the support members 12 in a particular way, the panels may be rotated 180 degrees, such that the first edge 34 is the second edge 36 without departing from the spirit and scope of the present disclosure. Additionally, the entire system may be rotated 90° such that the edges 34, 36 are oriented vertically not horizontally. Additionally, the panels may be located such that the edges 34, 36 are at any angle with respect to the ground (e.g., 10, 20, 30, 40, 50, 60, 70, 80, or the like degrees).

As will be appreciated by one of skill in the art in view of this disclosure, embodiments of the disclosure may be embodied as an apparatus, a system, computer program product, and/or other device, a method, or a combination of the foregoing. Accordingly, embodiments of the disclosure may take the form of an entirely hardware embodiment, an entirely software embodiment (including firmware, resident software, micro-code, etc.), or an embodiment combining software and hardware aspects that may generally be referred to herein as a “system.” Furthermore, embodiments of the disclosure may take the form of a computer program product comprising a computer-usable storage medium having computer-usable program code/computer-readable instructions embodied in the medium (e.g., a non-transitory medium, or the like).

Any suitable computer-usable or computer-readable medium, a volatile memory unit, non-volatile memory unit, or the like may be utilized. The computer usable or computer readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires; a tangible medium such as a portable computer diskette, a hard disk, a random access memory (RAM), a read-only memory (ROM), an erasable programmable read-only memory (EPROM, Flash, and/or NVRAM memory), a compact disc read-only memory (CD-ROM), or other tangible optical or magnetic storage device.

Expansion memory may also be provided and connected to end-point device(s) through an expansion interface (not shown), which may include, for example, a SIMM (Single In Line Memory Module) card interface. Such expansion memory may provide extra storage space for end-point device(s) or may also store applications or other information therein. In some embodiments, expansion memory may include instructions to carry out or supplement the processes described above and may include secure information also. For example, expansion memory may be provided as a security module for end-point device(s) and may be programmed with instructions that permit secure use of end-point device(s). In addition, secure applications may be provided via the SIMM cards, along with additional information, such as placing identifying information on the SIMM card in a non-hackable manner.

Computer program code/computer-readable instructions for carrying out operations of embodiments of the disclosure may be written in an object oriented, scripted or unscripted programming language such as Java, Pearl, Python, Smalltalk, C++ or the like. However, the computer program code/computer-readable instructions for carrying out operations of the disclosure may also be written in conventional procedural programming languages, such as the “C” programming language or similar programming languages. The computer program code/computer-readable instructions contains instructions that, when executed, perform one or more methods, such as those described herein. The information carrier may be a computer- or machine-readable medium, such as the memory, expansion memory, memory on processor, or a propagated signal that may be received, for example, over transceiver or external interface.

The systems may communicate through digital signal processing circuitry where necessary. The communication may occur under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver, such as radio-frequency transceiver. In addition, short-range communication may occur, such as using a Bluetooth, Wi-Fi, or other such transceiver (not shown). In addition, a GPS (Global Positioning System) receiver module may provide additional navigation- and location-related wireless data, which may be used as appropriate by applications running thereon, and in some embodiments, one or more applications operating on the systems.

The systems may also communicate audibly using an audio codec, which may receive spoken information from a user and convert the spoken information to usable digital information. The audio codec may likewise generate audible sound for a user, such as through a speaker (e.g., in a handset of systems). Such sound may include sound from voice telephone calls, may include recorded sound (e.g., voice messages, music files, etc.) and may also include sound generated by one or more applications operating on the systems, and in some embodiments, one or more applications operating on the system.

It should be understood that “operatively coupled,” “coupled”, and/or “connected” when used herein, means that the components may be formed integrally with each other, or may be formed separately and coupled together. Furthermore, “operatively coupled”, “coupled”, and/or “connected” means that the components may be formed directly to each other, or to each other with one or more components located between the components that are operatively coupled, coupled, and/or connected together. Furthermore, “operatively coupled”, “coupled”, and/or “connected” may mean that the components are detachable from each other, or that they are permanently coupled together.

Also, it will be understood that, where possible, any of the advantages, features, functions, devices, and/or operational aspects of any of the embodiments of the present disclosure described and/or contemplated herein may be included in any of the other embodiments of the present disclosure described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more.”

Certain terminology is used herein for convenience only and is not to be taken as a limiting, unless such terminology is specifically described herein for specific embodiments. For example, words such as “top”, “bottom”, “upper”, “lower”, or the like may merely describe the configurations shown in the figures and described herein for some embodiments of the disclosure. Indeed, the components may be oriented in any direction and the terminology, therefore, should be understood as encompassing such variations unless specified otherwise. The terminology includes the words specifically mentioned above, derivatives thereof and words of similar import.

While certain exemplary embodiments have been described and shown in the accompanying drawings, it is to be understood that such embodiments are merely illustrative of and not restrictive on the broad disclosure, and that this disclosure not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the disclosure. Therefore, it is to be understood that, within the scope of the appended claims, the disclosure may be practiced other than as specifically described herein.

What is claimed is:

1. An insulated panel, comprising:
a first substrate;
a second substrate;
an insulation material located between the first substrate and the second substrate;
one or more sensors located at least partially within the insulation material; or
one or more light devices operatively coupled to the first substrate or the second substrate.

2. The insulated panel of claim 1, wherein the insulated panel comprises the one or more sensors and the one or more light devices.

3. The insulated panel of claim 1, further comprising:
a panel hub, wherein the panel hub is configured to communicate with a main hub that is configured to communicate with a plurality of panel hubs of a plurality of insulated panels.

4. The insulated panel of claim 3, further comprising:
a panel hub housing located at least partially within the insulation material, wherein the panel hub housing at least partially encloses the panel hub.

5. The insulated panel of claim 4, wherein the panel hub housing is made at least partially from the insulation material.

6. The insulated panel of claim 3, wherein the panel hub is operatively coupled to the one or more sensors through a wired connection or a wireless connection.

7. The insulated panel of claim 3, wherein the first substrate or the second substrate comprises a circuit; and wherein the panel hub and the one or more sensors are operatively coupled through the circuit.

8. The insulated panel of claim 7, wherein the circuit is a printed circuit on the first substrate or the second substrate.

9. The insulated panel of claim 1, further comprising:
one or more electrical connectors, wherein the one or more electrical connectors operatively couple the one or more sensors of the insulated panel with one or more adjacent sensors of one or more adjacent insulated panels through wired connectors.

10. The insulated panel of claim 1, further comprising:
one or more electrical connectors, wherein the one or more electrical connectors are embedded into an edge or end of the insulated panel and operatively couple the insulated panel with one or more adjacent insulated panels when assembled on a structure.

11. The insulated panel of claim 1, wherein the one or more sensors comprise:
one or more pressure sensors, wherein the one or more pressure sensors are configured to indicate structural changes in the insulated panel or a structure on which the insulated panel is installed.

12. The insulated panel of claim 1, wherein the one or more sensors comprise:
one or more position sensors, wherein the one or more position sensors are configured to indicate structural changes in the insulated panel, a structure, or elements within the structure.

13. The insulated panel of claim 1, wherein the one or more sensors comprise:
one or more location sensors, wherein the one or more location sensors are configured to indicate a location of the insulated panel on a structure.

14. The insulated panel of claim 1, wherein the one or more sensors comprise:
one or more vison sensors, wherein the one or more vision sensors are configured to monitor elements outside or within a structure.

15. The insulated panel of claim 1, wherein the one or more sensors comprise:
one or more smoke sensors, wherein the one or more smoke sensors are configured to indicate the presence of a fire.

16. The insulated panel of claim 1, wherein the one or more sensors comprise:
one or more temperature sensors, wherein the one or more temperature sensors are configured to indicate the presence of a fire, an issue with the insulated panel, or utilized for climate control of a structure.

17. The insulated panel of claim 1, wherein the one or more sensors comprise:
one or more humidity sensors, wherein the one or more humidity sensors are configured to indicate an issue with a structure or utilized for climate control of the structure.

18. The insulated panel of claim 1, wherein the one or more sensors comprise:
one or more air flow sensors, wherein the one or more air flow sensors are configured to aid in regulating air flow within a structure or utilized for climate control of the structure.

19. The insulated panel of claim 1, wherein the one or more light devices are operatively coupled to an edge of the insulated panel, wherein the one or more light devices are exposed on an outer face of the insulated panel for lighting an exterior of a structure or wherein the one or more light devices are exposed on an inner face of the insulated panel for lighting an interior of a structure.

20. An insulated panel system, comprising:
a plurality of insulated panels, wherein two or more of the plurality of insulated panels comprise:
a first substrate;
a second substrate;
an insulation material located between the first substrate and the second substrate;
one or more sensors located at least partially within the insulation material, or one or more light devices operatively coupled to the first substrate or the second substrate;
a panel hub operatively coupled to the first substrate, the second substrate, or the insulation material;
a controller operatively coupled to the panel hub, the one or more sensors or the one or more light devices of the two or more of the plurality of insulated panels, wherein the controller comprises:
one or more memory devices with computer-readable program code stored thereon; and
one or more processing devices operatively coupled to the one or more memory devices, wherein when executed the computer-readable program code is configured to direct the one or more processing devices to:
receive sensor output from the one or more sensors and send a sensor notification regarding the sensor output; or
provide light commands to the one or more light devices to control the one or more light devices.

21. A method of operating an insulated panel system, wherein the insulated panel system comprising a plurality of insulated panels, wherein two or more of the plurality of insulated panels comprise one or more sensors located at least partially within insulation material between a first substrate and a second substrate, or one or more light devices operatively coupled to the first substrate or the second substrate, and a panel hub located at least partially within the insulation material, the method comprising:
receiving, via one or more processing devices, sensor data from the one or more sensors and sending, via the one or more processing devices, a sensor notification regarding the sensor output; or
providing, via the one or more processing devices, light commands to the one or more light devices to control the one or more light devices.

22. A method of manufacturing an insulated panel, the method comprising:
providing a first substrate adjacent a second substrate;
applying insulation material between the first substrate and the second substrate through continuous manufacturing systems or discontinuous manufacturing systems;
installing one or more sensors or a panel hub by operatively coupling the one or more sensors or the panel hub to the first substate, the second substrate, or the insulation material, before or after the insulation material is applied between the first substrate and the second substrate;
optionally installing one or more light devices by operatively coupling the one or light devices to the insulated panel.
